(19) United States
(12) Patent Application Publication
(10) Pub. No.: US 2016/0292596 A1
(43) Pub. Date: Oct. 6, 2016

(54) METHODS AND SYSTEMS FOR SCHEDULING A SHARED RIDE AMONG COMMUTERS

(71) Applicant: RIDE GROUP, INC., Philadelphia, PA (US)

(72) Inventors: Oscar Salazar GAITAN, Colima (MX); Maria Jesus VERDUGO PARRA, Santiago (CL); Gleb CHUVPILO, New York, NY (US); Gustavo Rodolfo BARRON MIJARES, Queretaro (MX); Olivia Falcony SERRATOS, Queretaro (MX); Ann FANDOZZI, Conshohocken, PA (US)

(21) Appl. No.: 15/037,654

(22) PCT Filed: Nov. 21, 2014
(86) PCT No.: PCT/US14/66934

§ 371 Date: May 18, 2016

Related U.S. Application Data
(60) Provisional application No. 61/907,080, filed on Nov. 21, 2013.

(51) Int. Cl. G06Q 10/02; G06F 17/30; G06Q 10/06

(52) U.S. Cl. CPC G06Q 10/025; G06Q 10/0631; G06F 17/30864

(57) ABSTRACT

Methods and systems for scheduling a shared ride among commuters are disclosed. A shared ride may be created by first receiving a destination area and ride input factors from a rideshare subscribed entity, then generating a unique URL associated with the destination area. The unique URL is then transmitted to potential commuters. Users who access the URL input their commuter registration information, which may include commuter travel information, work schedule, home address, and whether the commuter currently drives or carpools to a destination location. A rideshare group is formed by applying a group formation algorithm with the processor to the commuter registration information, the destination area, and the at least one ride input factor to generate an output representing identity information for the rideshare group of commuters, at which point a shared ride is scheduled.

### CROSS-REFERENCE TO RELATED APPLICATIONS

This application claims priority to U.S. Patent Application No. 61/907,080, filed Nov. 21, 2013, entitled “METHODS AND SYSTEMS FOR SCHEDULING A SHARED RIDE AMONG COMMUTERS”, the contents of which are incorporated herein by reference.

### FIELD OF THE INVENTION

The present invention relates to rideshare systems and methods, and, more particularly, to carpool and vanpool methods and systems that incorporate input from a subscribed entity, which means a business entity, such as a company, university, rideshare provider, or an entity partnering with a rideshare provider, to generate a shared ride for commuters travelling to a destination address or destination area. A commuter according to the invention may be, for example, a user of the rideshare system, or a customer, and includes potential drivers, drivers or riders.

### BACKGROUND INFORMATION

Ridesharing has become popular in recent years in view of the heightened effort to promote reducing congestion on the nation's public roadways, reducing carbon-based fuel consumption, which in turn reduces the percentage of CO2 released into the atmosphere, and increasing job and education accessibility to individuals who otherwise could not get to their workplace or campus. The current state of the art is flawed and inefficient. On-line carpool and vanpool systems and services that exist today are available to commuters interested in sharing a ride to a common destination or destination area. In a typical system, commuters initiate the request for a carpool or vanpool and are required to provide a preferred pickup location, their destination address, and their desired transportation schedule. If the system finds existing carpools or vanpools that are within specified parameters that are set based on the commuter-supplied information, it provides those matches to the commuter, and the commuter has the option to select one of those rides. If no match is found, the commuter may create a new group and publish it online. At some point in the future, if other commuters join the group, a new carpool or vanpool may be formed. Such existing business-to-consumer systems are very inefficient because they do not assimilate a group of people for a carpool or vanpool in an expeditious or meaningful way. Improved methods and systems for implementing carpools and premium rides, such as vanpools, are desirable.

### SUMMARY OF THE INVENTION

In accordance with one aspect of the present invention, a computer implemented method for scheduling a shared ride between a first commuter and a second commuter is disclosed. Business entities, such as companies, businesses and universities, may participate in, partner with others, and/or control to some degree the formation of carpools and vanpools for their employees and/or faculty and students who commute to a common destination or destination area for work or school. According to another aspect of the invention, the common destination or destination area may be an event, such as a concert, sporting event, show, protest, march, or other gathering that a group of commuters may be interested in traveling to in a shared ride. Business entities, such as rideshare providers may promote and form shared rides to such events according to methods and systems of the invention. Another aspect of the invention provides the business entity with the ability to set criteria for the formation of particular pools, and provides the business entity with feedback on data related to the pools created. Another aspect of the invention provides a dashboard for the subscribed entity to track data associated with shared rides set up through systems of the invention. These aspects of the invention create business to business to consumer systems and methods, which generate meaningful shared rides to common destinations or destination areas. Business to consumer systems and methods may also be realized according to aspects of the invention. Systems and methods of the invention further serve to facilitate achieving and maximizing environmental sustainability goals by reducing the carbon footprint of commuters travelling to work and/or school and increasing access to workplaces and educational institutions.

The inventors have discovered that current systems create unnecessary friction and rely upon the commuters to “self-select” into an existing ride from a long list of possible rides and puts commuters in the uncomfortable position of calculating, allocating, handling and collecting the payments for the shared ride. The invention removes this awkwardness and manual bookkeeping by calculating, assessing, charging and collecting payments electronically and providing clear records and receipts to commuters. Aspects of the invention solves this problem by using an algorithm based on various input factors to do the searching for the commuters and offer the commuters their best ride to work or campus, not just a list of many rides travelling to and from the same general pick up and destination points. The system also has the ability to invite participants in an existing carpool or vanpool into the system, intake their specific user information, group these users into a shared ride and provide all of the other benefits of the system to this group as if the system had matched the participants and formed a shared ride.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 is a block diagram illustrating an exemplary system in accordance with aspects of the present invention;

FIG. 2 is a flowchart illustrating an exemplary method for forming a shared ride in accordance with aspects of the present invention;

FIGS. 3A-3T are renderings illustrating exemplary displays for implementing portions of a method of FIG. 2, in accordance with aspects of the present invention;

FIGS. 4A and 4B illustrate a flowchart of an exemplary method for forming a shared ride in accordance with aspects of the present invention;

FIGS. 5A-5D illustrate a decision tree flow diagram of an exemplary method for forming a shared ride in accordance with aspects of the present invention;

FIGS. 6A and 6B illustrate a flowchart of another exemplary method for forming a shared ride in accordance with aspects of the present invention;

FIGS. 7A-7C illustrate a decision tree flow diagram of another exemplary method for forming a shared ride in accordance with aspects of the present invention; and

FIGS. 8A-8H are renderings illustrating exemplary displays for implementing portions of a method of FIG. 7, in accordance with aspects of the present invention.

### DETAILED DESCRIPTION OF THE INVENTION

The exemplary systems and methods usable in conjunction with electronic systems described herein are directed toward creating shared rides between commuters travelling to a common destination or destination area, and to provide feedback data to subscribed entities related to those rides.

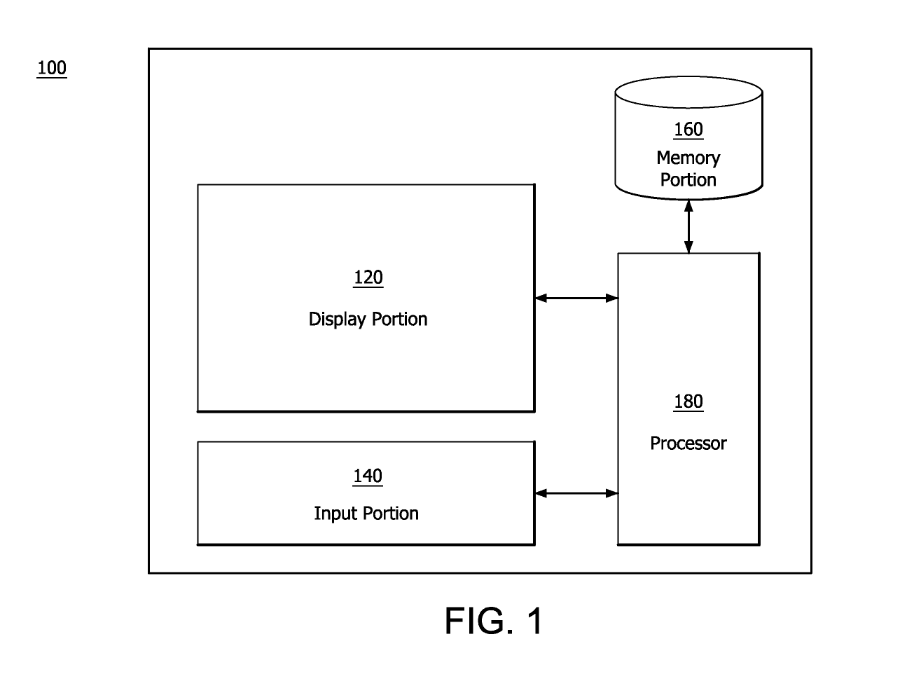

Referring now to the drawings, FIG. 1 illustrates a rideshare system 100 in accordance with aspects of the present invention. Rideshare system 100 is usable to perform ride matching for commuters and provide information related to the ride to the commuters and a subscribed entity. Rideshare system 100 may be, a computer, or a portable electronic device such as, for example, a tablet computer or a smart phone. As a general overview, rideshare system 100 includes a display portion 120, an input portion 140, a memory portion 160, and one or more processors 180. Additional details of rideshare system 100 are described herein.

Display portion 120 presents information to a user of the rideshare system 100, such as, for example, a commuter, a subscribed entity, or an asset provider. A user may also be anyone or anything capable of supplying or receiving data and having access to the rideshare system 100. Display portion 120 is in communication with the other components of rideshare system 100 via conventional wired or wireless connections. Display portion 120 may be directly or indirectly connected to the rest of the components of rideshare system 100. The display portion 120 may be an electronic display such as, for example, a monitor attached to a desktop computer, a laptop display, or a smart phone. Other suitable components for use as display portion 120, such as a portable electronic display, will be known to one of ordinary skill in the art from the description herein.

Input portion 140 enables the receipt of information from the users of rideshare system 100. Input portion 140 further transmits the received information to processor 180 for use in operating rideshare system 100. In one embodiment, display portion 120 may comprise a touch screen (in addition to or in place of any other display components). In this embodiment, the touch screen may also be configured to function as input portion 140. In an alternative embodiment, input portion 140 may be a separate component configured to receive input from a user. For example, input portion 140 may be a keypad, mouse, button, or other conventional input device. Suitable components for use as input portion 140 will be known to one of ordinary skill in the art from the description herein.

Memory portion 160 stores data for rideshare system 100. For example, memory portion 160 stores data comprising user information received by the rideshare system 100, which may include commuter registration information, Memory portion 160 may further store data comprising subscribed entity information, which may include an entity destination address, a unique uniform resource locator (URL) associated with the subscribed entity, and ride data. Suitable memory components for use as memory portion 160 will be known to one of ordinary skill in the art from the description herein.

Processor 180 controls the operation of rideshare system 100. Processor 180 is operable to control the information displayed on display portion 120. Processor 180 is further operable to store and access data in memory portion 160. In particular, processor 180 is programmed to implement methods for scheduling a shared ride between commuters using rideshare system 100, such as, for example, method 200, method 400, method 500, method 600, and method 700, in combination with the display portion 120, memory 160, and input portion 140, as described herein. Processor 180 may also be programmed to implement a method for providing the subscribed entity with ride data associated with the share ride. Processor 180 may include one or more processors for carrying out one or more of the steps for scheduling shared rides, according to aspects of the invention. Additional details of method 200, method 400, method 500, method 600, and method 700 are set forth below.

The inventive concepts outlined in such methods amount to an improvement in the function of rideshare system 100, and improvements in the field of transportation. In addition to and apart from those improvements, methods and systems of the invention provide improvements in the fields of energy consumption, the conservation of natural resources, and environmental protection. For example, methods and systems of the invention provide improvements in the field of energy by creating shared rides that reduce the amount of vehicles on the road, and hence reducing the amount of energy expended to power such vehicles. Methods and systems of the invention also improve the field of preserving natural resources, by providing systems and methods that serve to reduce the amount of vehicles on the road, thereby reducing the amount of fuel expended to power those vehicles. The invention also improves the technological field of engineering by providing methods and systems that serve to reduce the carbon footprint created by vehicles on the road by consolidating independent travelers into shared rides to common destinations or destination areas and lessening the impact of vehicles on the nation's highways and roadways. Methods and systems of the invention have had a favorable impact on highway infrastructure and civil engineering challenges by removing approximately 125,000 car trips per day from the roads. Adding to the improvements in these fields, the invention serves to further consolidate the use of vehicles on the road by providing systems and methods that proactively serve to consolidate carpools into premium rides, such as vanpools.

It will be understood that rideshare system 100 is not limited to the above components, but may include alternative components and additional components, as would be understood by one of ordinary skill in the art from the description herein. For example, processor 180 may include multiple processors, e.g., a first processor for controlling information displayed on display portion 120 and a second processor for controlling storage and access of data in memory portion 160.

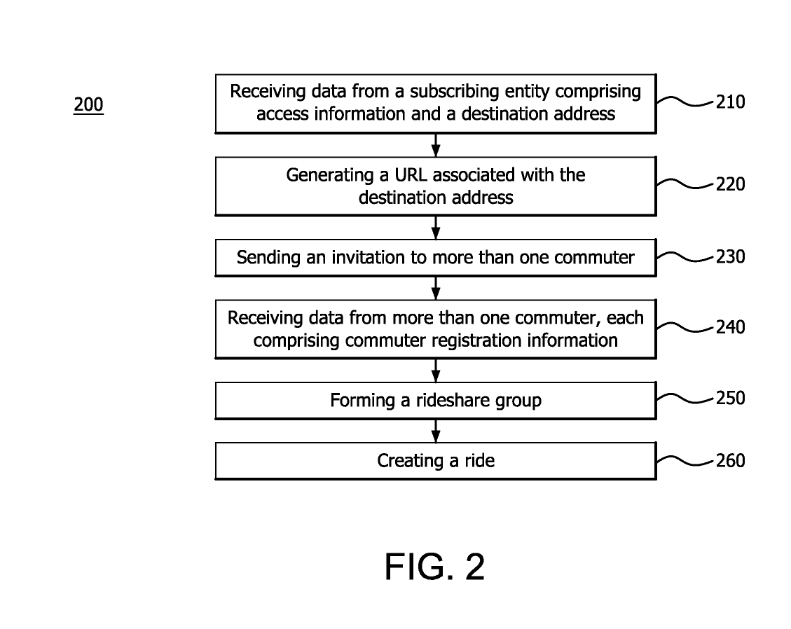

FIG. 2 shows an exemplary method 200 for forming a shared ride in accordance with aspects of the present invention. Method 200 may desirably be implemented on rideshare system 100. As a general overview, method 200 includes receiving data from a subscribing entity, generating a URL associated with a destination address, sending an invitation to a commuter, receiving data from the commuter, forming a rideshare group, and creating a shared ride. Additional details of method 200 are described herein with respect to the components of rideshare system 100.

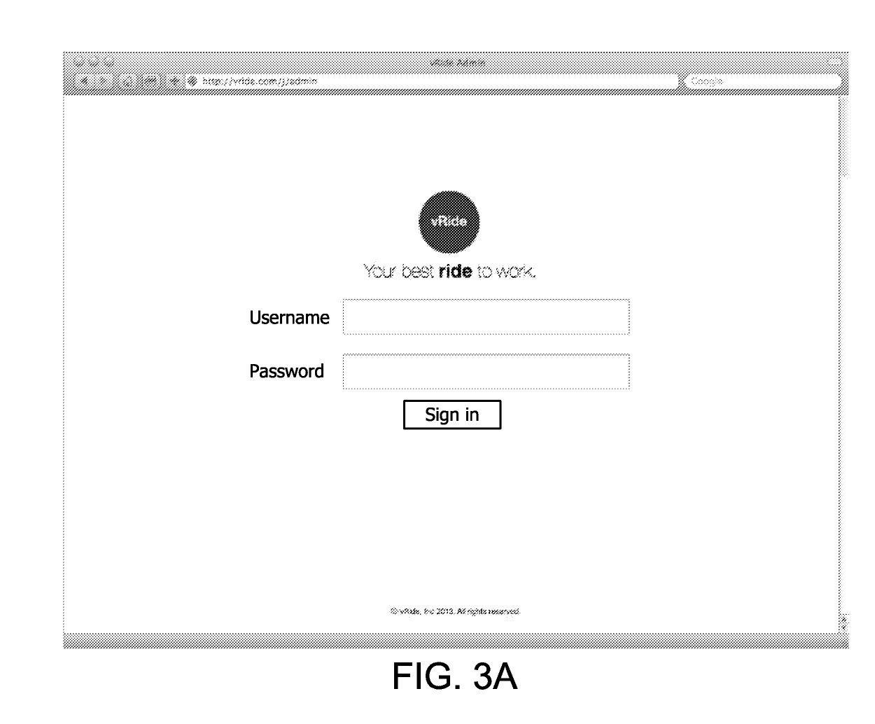

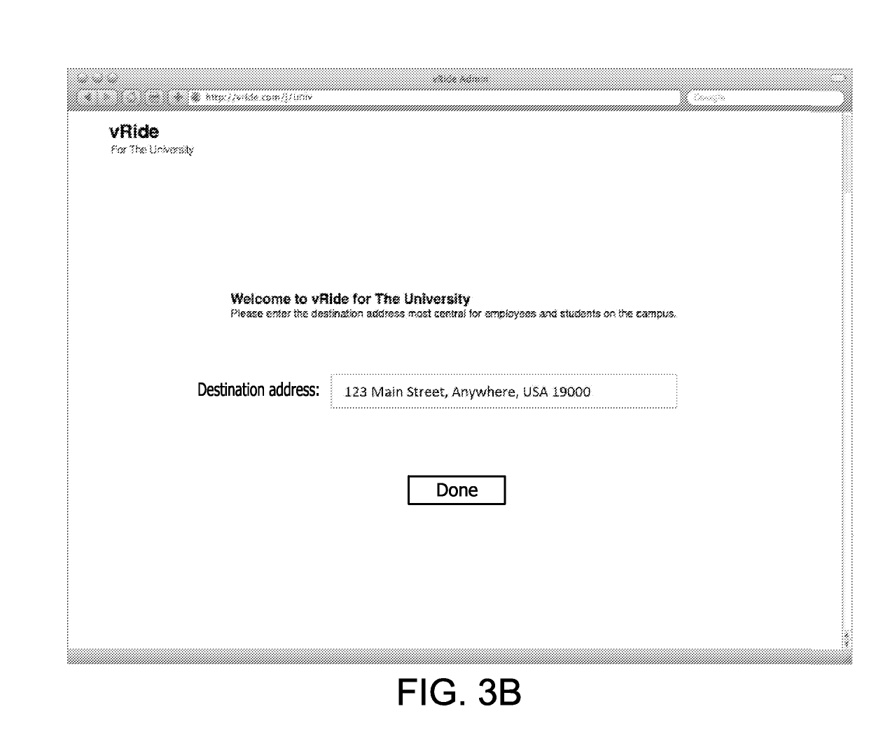

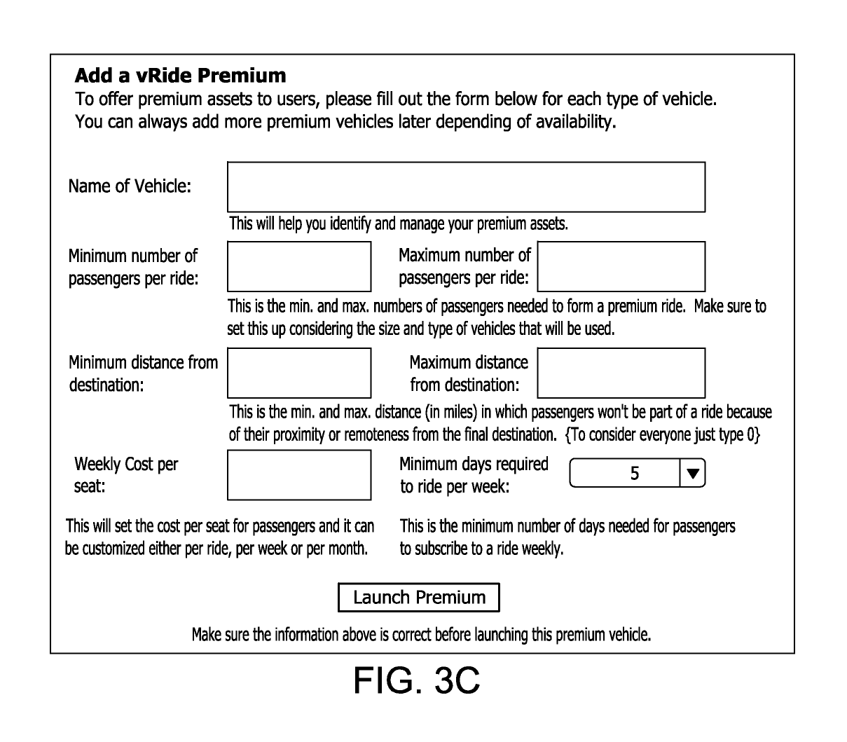

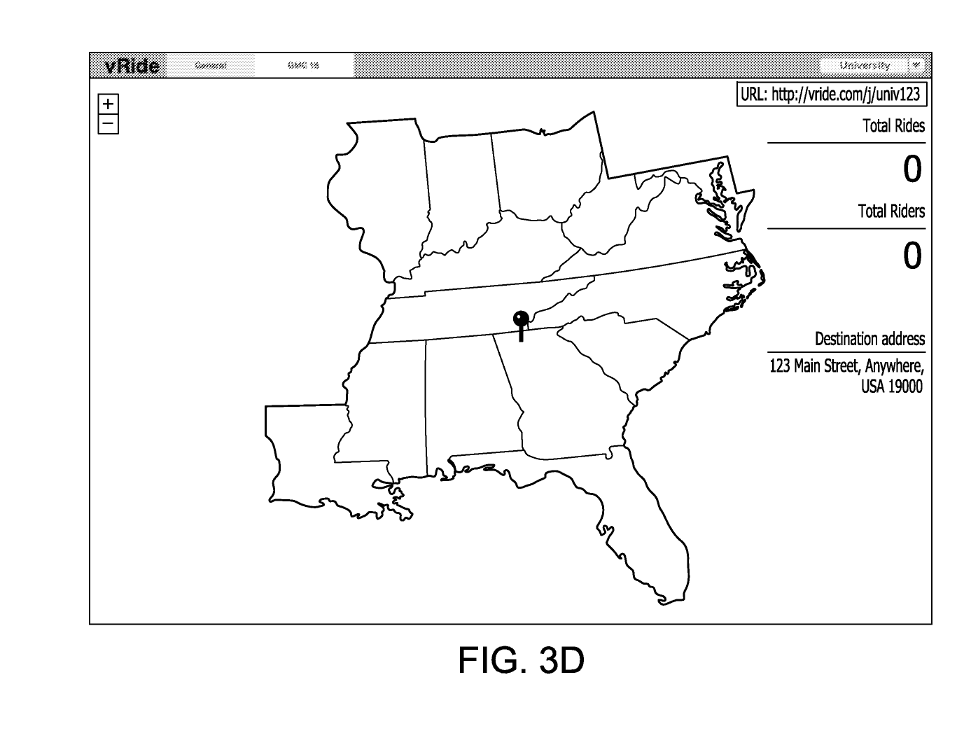

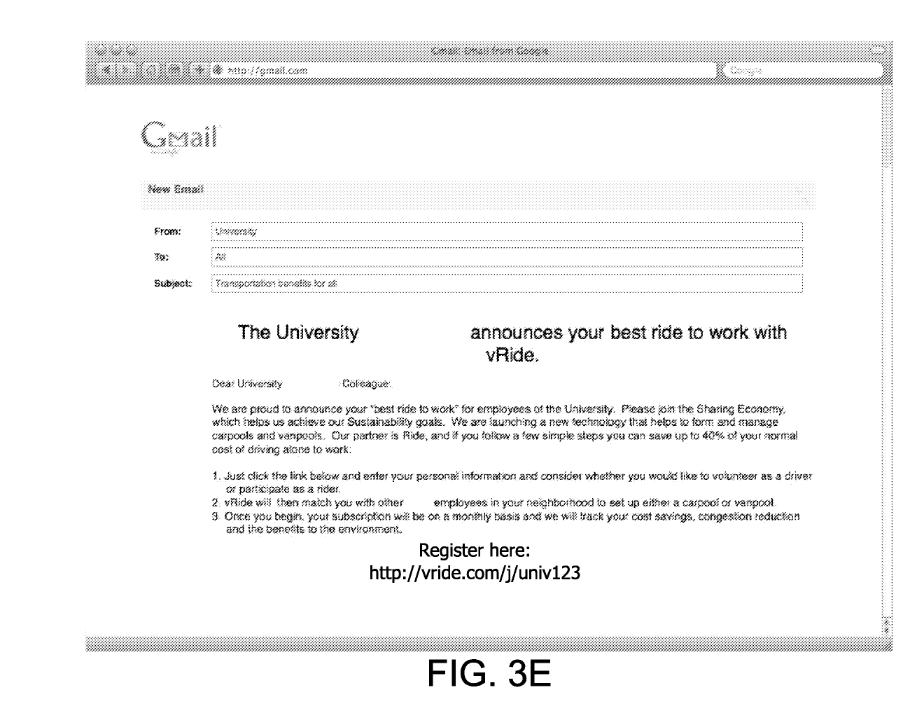

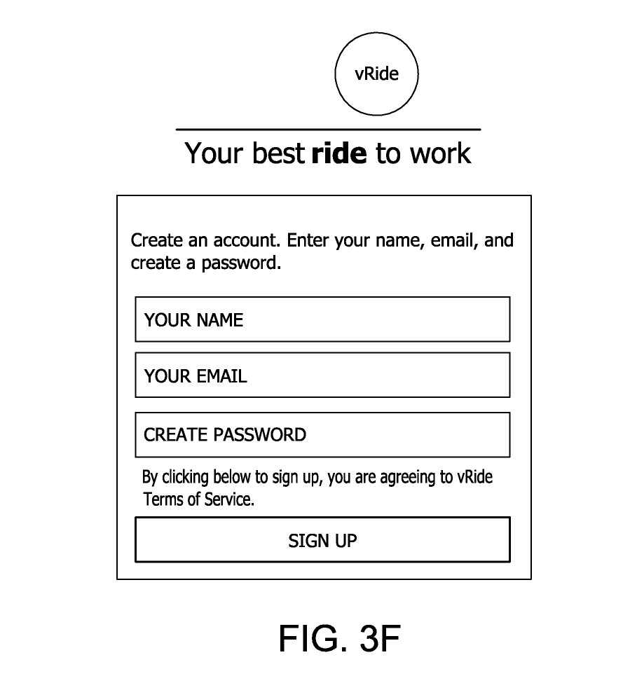

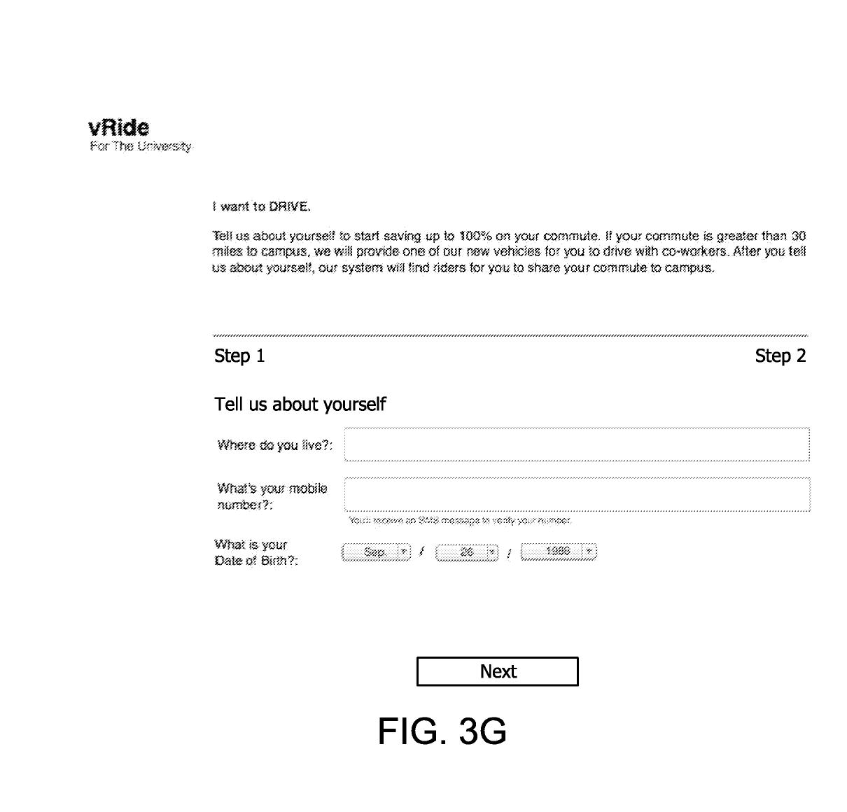

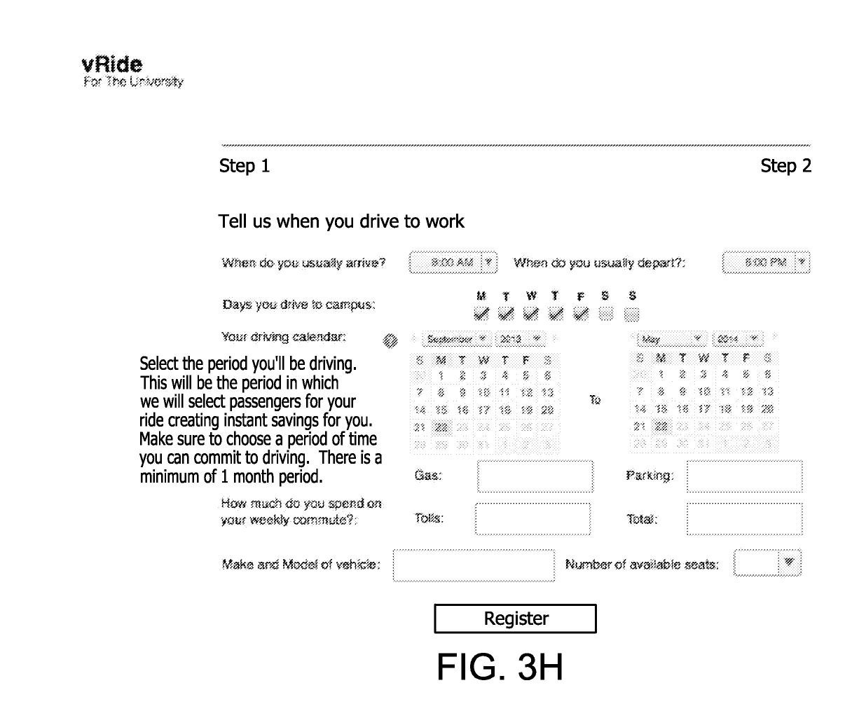

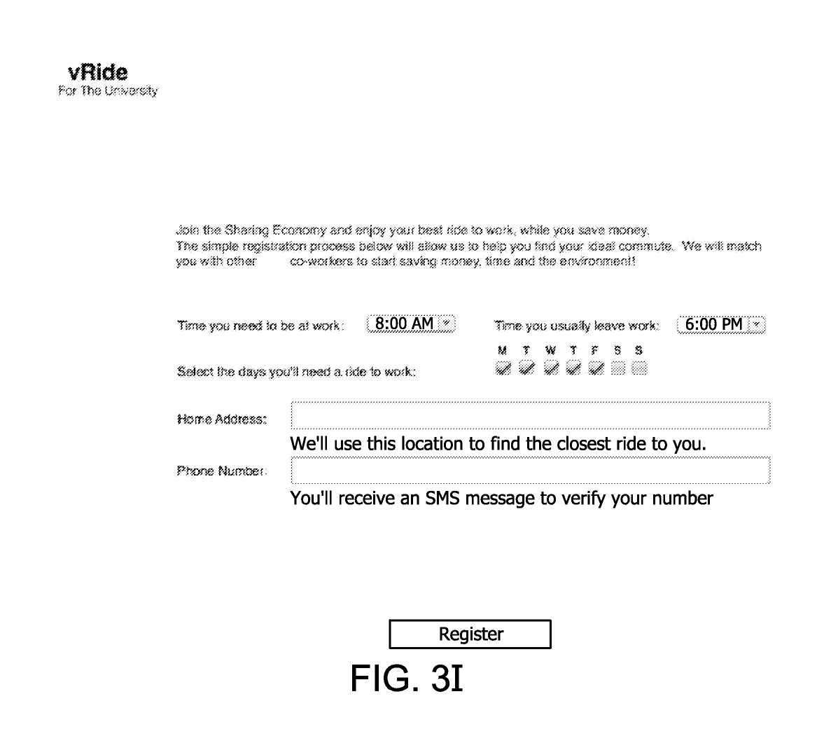

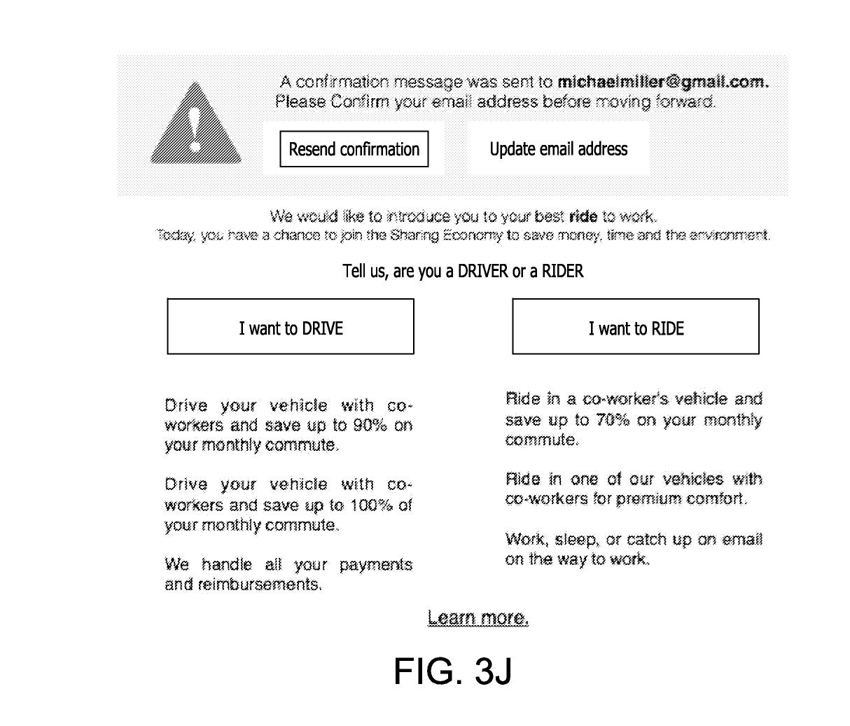

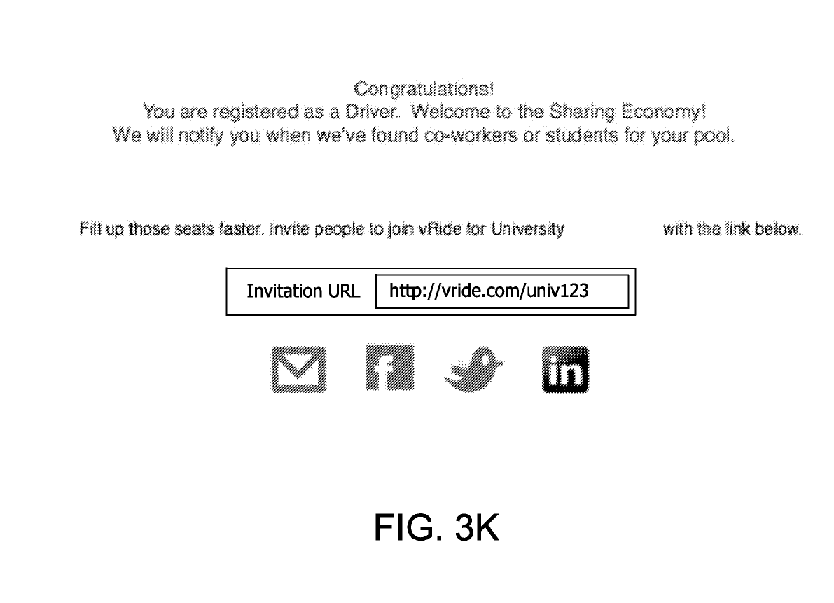

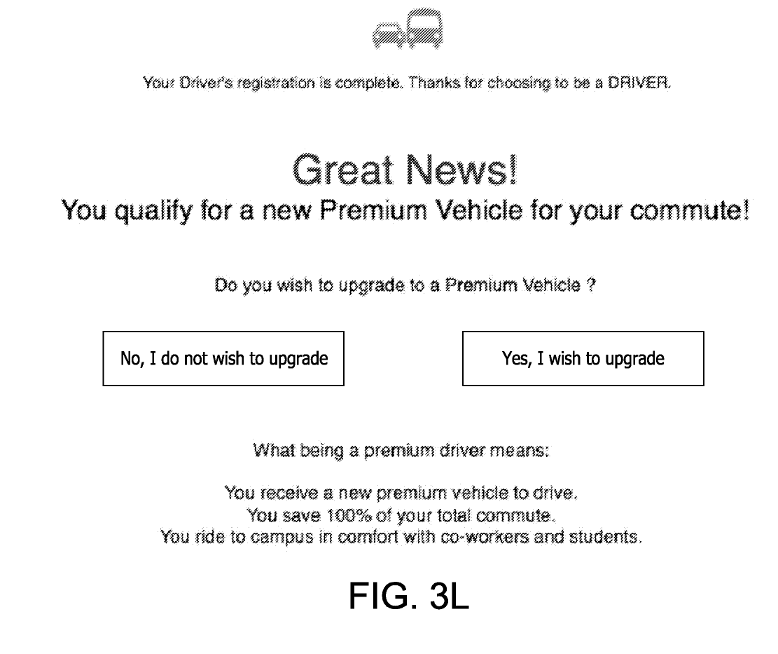

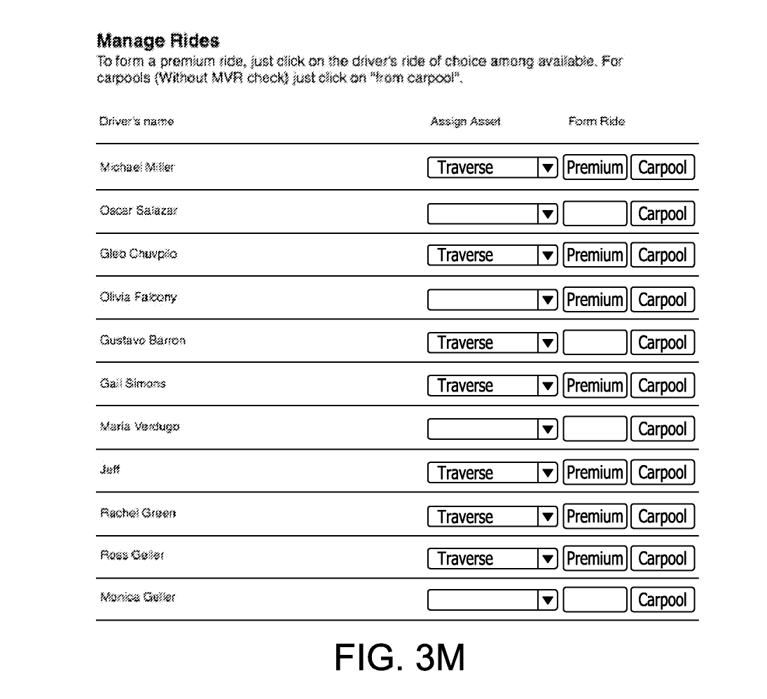

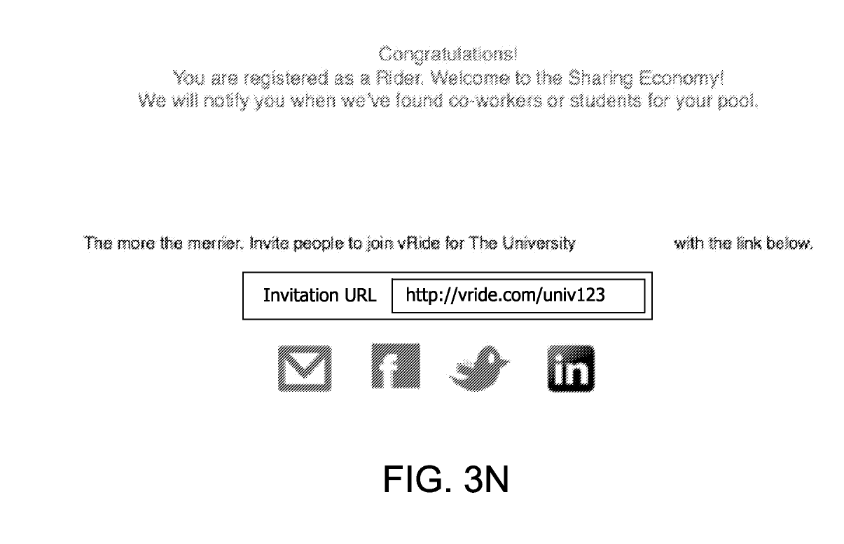

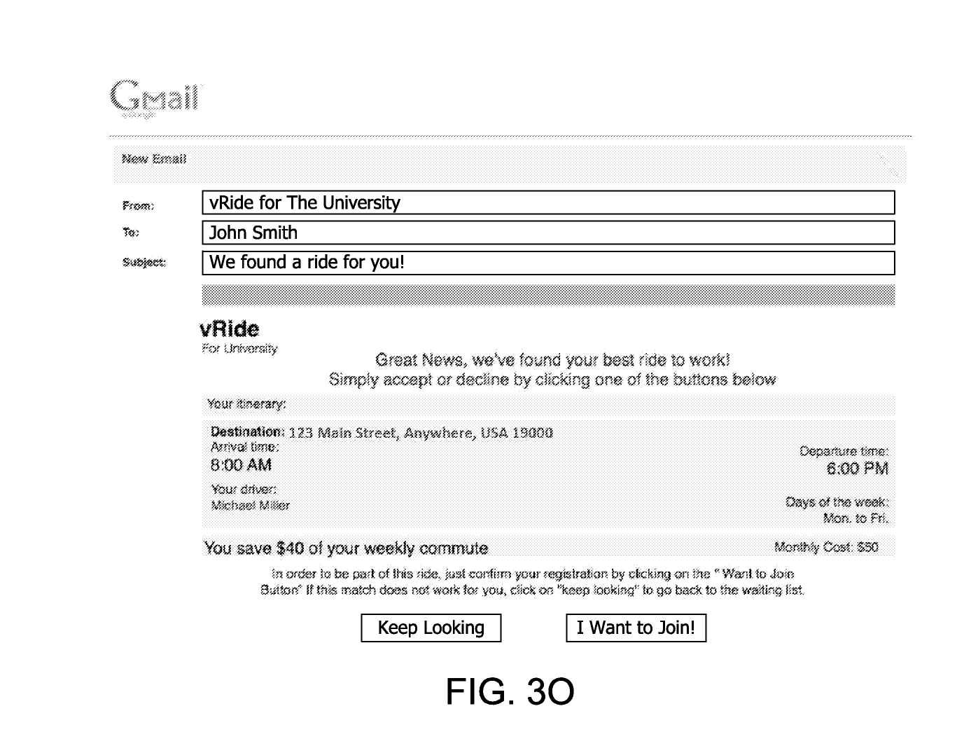

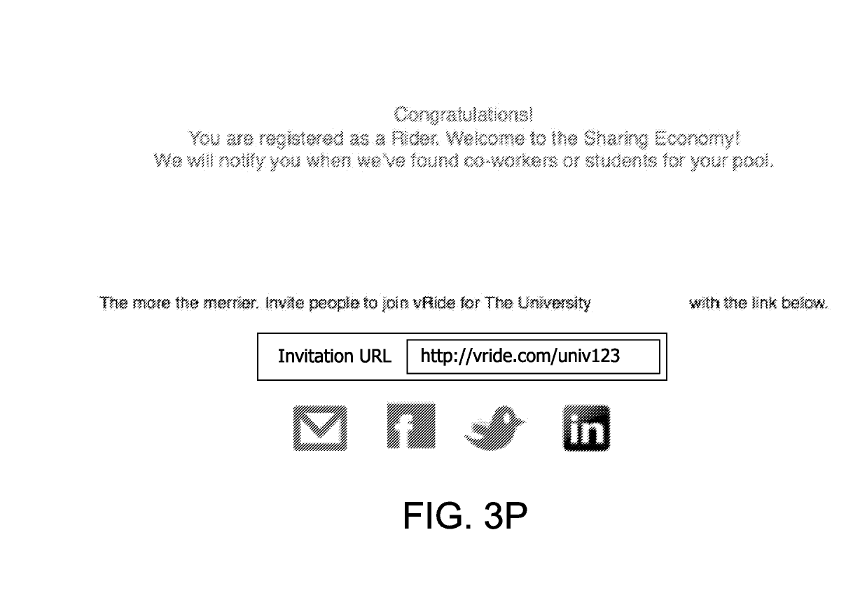

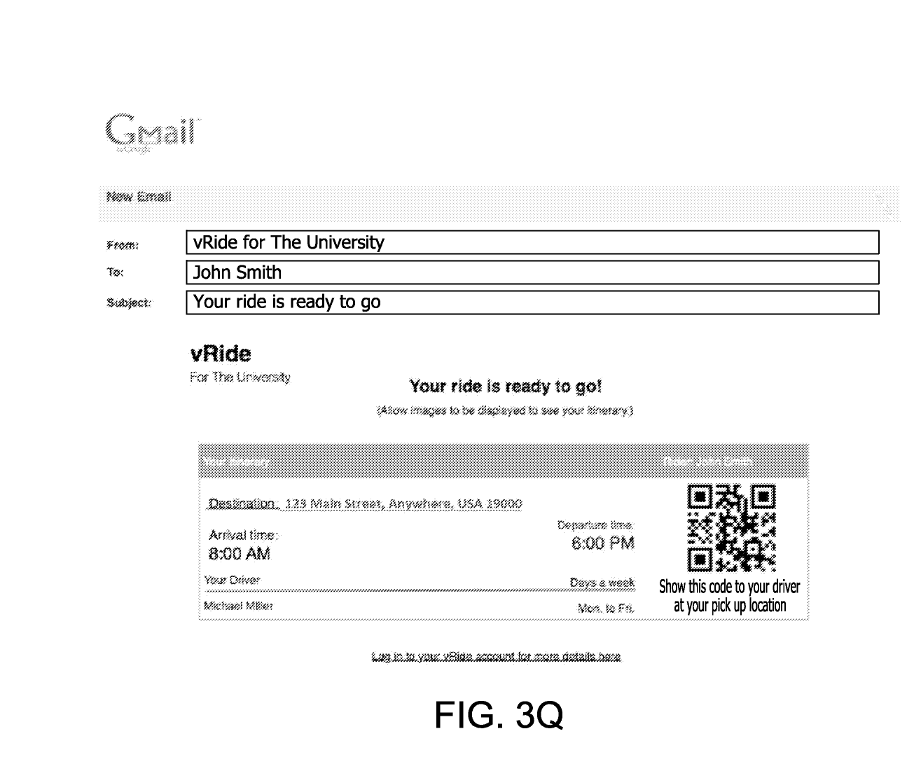

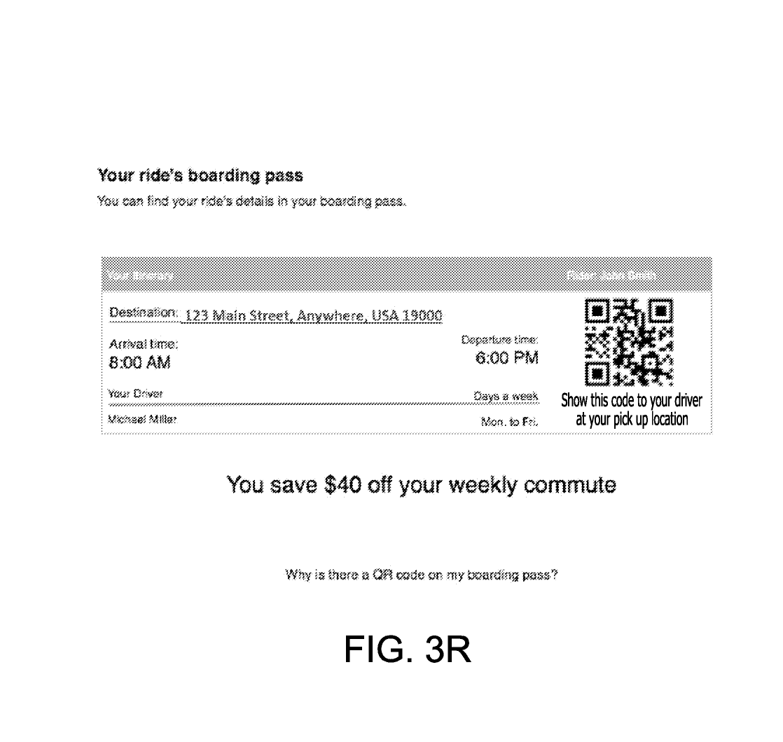

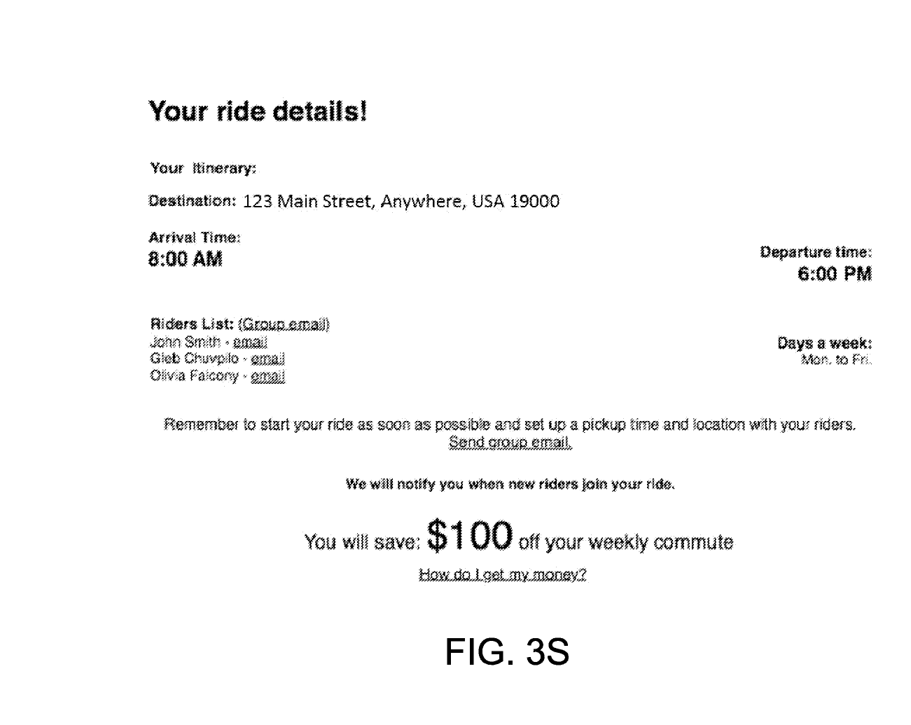

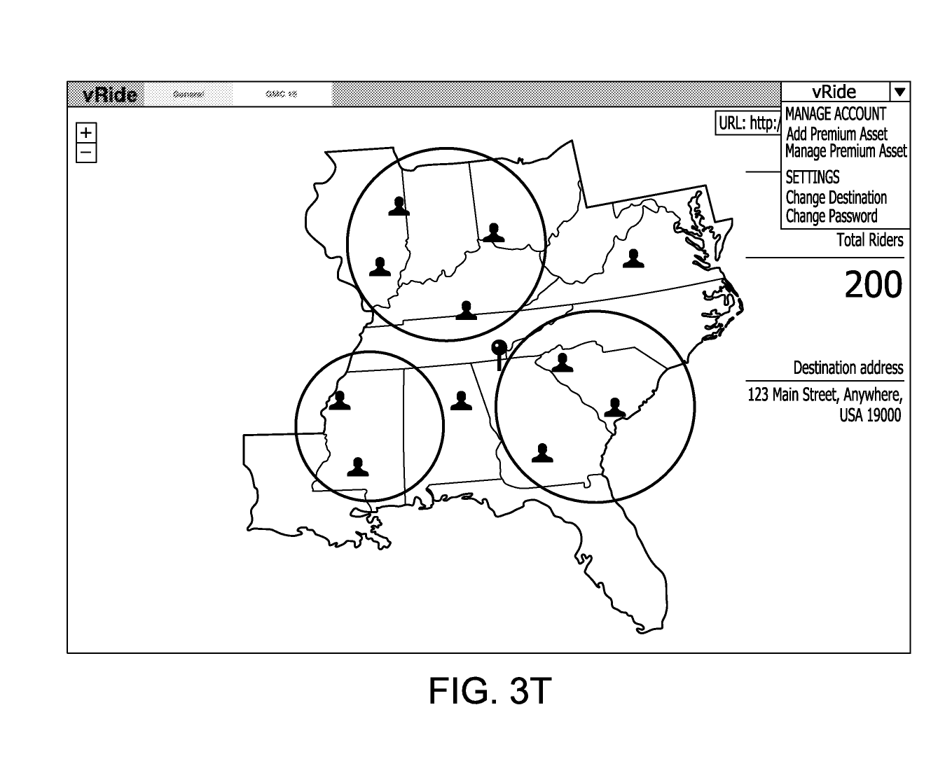

In step 210, data is received from a subscribed entity. In an exemplary embodiment, the subscribed entity uses input portion 140 to enter data into rideshare system 100 and the data is stored in memory 160. The subscribed entity data comprises access information, such as a username and password, and a destination area, which preferably is a destination address, and more preferable is an entity destination address. Exemplary displays for prompting entry of data from a subscribed entity in this step are shown in FIGS. 3A and 3B.

In an exemplary embodiment, data received from the subscribed entity may further comprise at least one ride input factor. Ride input factors are taken into account when forming a rideshare group, as discussed in connection with step 250 below, and may be received at any time before or during formation of the rideshare group. A ride input factor permits subscribed entities, administrators and other authorized users to impose parameters on the formation of rideshare groups. Examples of ride input factors may include required, number (or range of number) of passengers per ride, ride pickup location, rider distance (or range of distance) to the ride pickup location, rider distance (or range of distance) to entity destination, rider age (or range of age), minimum number of travel days per time period, cost per seat, and rider classification (i.e. executive, staff, student, department, building location etc.) In an exemplary embodiment, subscribed entities, administrators and other authorized users input ride input factors when adding a ride asset, such as a car or van, to the rideshare system 100, although it is contemplated that ride input factors may be input into memory 160 at any time. Ride asset information, which preferably comprises asset type and available seats, may be received and stored in memory 160 at anytime before or at step 250. An illustration of an exemplary display for prompting entry of ride input factors is shown in FIG. 3C.

In another exemplary embodiment, data received from the subscribed entity may further comprise contact information for one or more commuters associated with the subscribed entity, such as, for example, employees, contractors, partners, or students. In this embodiment, rideshare system 100 stores the contact information in memory 160, and the processor 180 may access it to send invitations as described in step 230 below. Contact information may be input into the rideshare system 100 before, during or after step 210.

In step 220, a uniform resource locator (URL) associated with the destination address entered by the subscribed entity is generated. In an exemplary embodiment, processor 180 of rideshare system 100 may be programmed to generate a unique invitation URL based on the subscribed entity data. In another exemplary embodiment, a business dashboard is created. The business dashboard is associated with the subscribed entity and may be associated with one or more destination addresses. The business dashboard may also make available to the subscribed entity ride and rider information gathered through systems of the invention from time to time, in accordance with aspects of the invention and as described herein. An exemplary business dashboard display is shown in FIG. 3D. In an exemplary embodiment, the processor 180 of rideshare system 100 may be programmed to create the business dashboard by processing input received via input portion 140, then displaying it on display portion 120 of the subscribed entity.

In step 230, the URL of step 220 is electronically sent to a commuter who may be interested in commuting to and/or from the destination address. An exemplary invitation to join the ridesharing system is shown in FIG. 3E. Preferably, as shown in FIG. 2, invitations are sent to more than one prospective rider, with the intent of receiving commuter registration information from several prospective riders, as described in step 240, to form a rideshare group, as described in step 250. By accessing the URL, the commuter may create a new user account manually, sign in to an existing account, or sign in through third party applications such as, for example, Facebook or Twitter, in a manner known in the art. An illustration of an exemplary display for prompting information to create a rideshare user account, or to sign in to an existing account is shown in FIG. 3F. Alternative methods of accessing existing accounts or creating new accounts, whether now known or created in the future, are contemplated by the invention, as would be readily understood to one of ordinary skill in the art.

In step 240, data is received from a commuter comprising commuter registration information. Preferably, as shown in FIG. 2, commuter registration information for more than one prospective rider is received. The commuter registration information may include, for example, commuter access information, such as a user name and password, commuter address, commuter work address, commuter telephone number, commuter work or personal email address, date of birth and picture. Exemplary displays for prompting input of commuter registration information are shown in FIGS. 3F-3G. Commuter registration information may further include desired commuter travel information, such as, for example, commuter time of arrival, commuter time of departure, a selection of the days of the week the commuter travels or desires to travel to the destination address, current commuting habits, such as whether the commuter is currently carpooling or not, vehicle type, number of vehicle seats available, and current travel expenses. Exemplary displays for prompting input of additional commuter registration information are shown in FIGS. 3H-3I. In an exemplary embodiment, the commuter uses input portion 140 to enter data into rideshare system 100 and the data is processed by processor 180 and stored in memory 160.

In an exemplary embodiment, commuter registration information may also include whether the user desires to be a driver or a rider, or whether the user elects to serve in either role. An illustration of an exemplary display for prompting input from a commuter to select whether the commuter would like to be a driver or rider is shown in FIG. 33. In an exemplary embodiment, if the rideshare system 100 receives data through input portion 140 that the commuter desires to be a driver, the processor 180 of rideshare system 100 process that request and transmits a request for additional commuter registration information, which may comprise the commuter's date of birth, a typical arrival time to the destination address, a typical departure time from the destination address, a selection of days of the week the commuter wishes to drive to destination address, a driving period, current commuting expenses, and asset type (i.e. make and model of vehicle and number of available seats). In another embodiment, additional commuter registration information may be received at the time the commuter elects to be a driver. In another embodiment, the additional commuter registration information may be received by rideshare system 100 at any time. Exemplary displays for prompting input from a commuter requesting to be a driver are shown in FIGS. 3G-3H. In yet another embodiment, rideshare system 100 processes the commuter registration information and provides a recommended role for the commuter. For example, if the commuter does not have a car, embodiments of the invention would not provide the commuter with the option to be a driver. But if the commuter has a car, for example, and has not been a part of a carpool in the past, and has a commuting schedule that meets the needs of other riders in the rideshare system 100, the system may recommend that the commuter serve the role of a driver.

One or more driver criteria may be received by the rideshare system 100 and stored in memory 160. Driver criteria may comprise, for example, a minimum age, a driving distance from the commuter address to the destination address, driver rating and/or driver history (i.e. number of tickets, number of accidents, driving experience, years driving, timeliness, comments or feedback from riders on the driver, etc.). However, the invention is not so limited. In an exemplary embodiment, the processor 180 is programmed to analyze a commuter's request to be a driver, the commuter's registration information, and one or more driver criteria. The output may be, for example, a driver approval, driver denial, a request for additional information, an invitation to upgrade to another asset (i.e. upgraded car or van), a notification of an upgrade, or a request for further review. An illustration of an exemplary display of a driver approval is shown in FIG. 3K. An illustration of an exemplary display for prompting input from a commuter in response to an invitation from rideshare system 100 to upgrade to another asset is shown in FIG. 3L. In a preferred embodiment, driver approval by an administrator of rideshare system 100 may be required before upgrade to another asset. An illustration of an exemplary display for an administrator to approve or deny an upgrade to another asset is shown in FIG. 3M. In an exemplary embodiment, the business dashboard is updated with commuter registration information after the commuter registers. In another exemplary embodiment, rideshare system 100 may also digitally transmit to the registered commuter an invitation to invite others to register on the rideshare system 100 by, for example, sending an electronic message comprising the URL in step 220 and step 230 and a request to send it to others. An illustration of an exemplary display of an invitation to invite others to register on the rideshare system 100 is shown in FIG. 3N. The system will also permit a registered user to invite others, or to allow the system access to the user's social media contracts to invite others, to register for the service and join the user's ride or another ride identified by the system. Through the user's use of a unique code provided to them prior to registration, the invention will also allow users to register in the system and be grouped with an existing shared ride.

In step 250, a rideshare group is formed. In an exemplary embodiment, processor 180 is programmed to access the stored commuter registration information for each commuter, the one or more ride input factors, the destination address, and the ride asset information from memory 160. In this embodiment, the processor 180 analyzes said accessed information, one or more ride input factors, and the destination address, by executing a group formation algorithm. The group formation algorithm may be any such algorithm known to one of ordinary skill in the art that is implemented to cluster a group based on information about members of the group. In an exemplary embodiment, if the processor 180 outputs a rideshare group of commuters, it creates a ride invitation and transmits it to those commuters in the group. An illustration of an exemplary display of a ride invitation is shown in FIG. 3O. In another exemplary embodiment, the processor 180 is programmed to select a pickup location for the shared ride. The pickup location in this embodiment may be selected based on pickup location criteria, such as, for example, distance from the prospective riders, access to highways, parking availability, and safety. In another embodiment, the pickup location may be manually entered into the rideshare system 100 by a user of the system, such as, for example, a driver, an asset owner, or another authorized user.

In an exemplary embodiment, the ride invitation comprises the ride itinerary, which may comprise the destination address, the arrival and departure time from the destination address, the days of the week for the ride, the name of the driver, the driver's contact information, and/or metrics related to cost savings by joining the ride. Commuter registration information for commuters who do not receive a ride invitation remains available to the processor 180 in subsequent executions of the group formation algorithm. These commuters are considered to be on the waiting list for a shared ride. An illustration of an exemplary display of a waitlist notification transmitted to commuters is shown in FIG. 3P.

In step 260, a shared ride is created or formed. In an exemplary embodiment, after a commuter receives the ride invitation in step 250, the commuter is requested to transmit back to the rideshare system 100 whether the commuter accepts or declines the invitation. See, for example, FIG. 3O. In an exemplary embodiment, if an invitee accepts the invitation in step 250, a ride is created. The predetermined number may be, for example, based on seats available in an asset, calculated by the processor 180, or may be received by the system through input 140 by an authorized user. Customer payment information may also be requested or input into the rideshare system 100 at the time, or after the commuter accepts the invitation. The rideshare system 100 also may provide the commuter with the option to decline the invitation, in which case the commuter registration for that commuter remains available to the processor 180 in subsequent executions of the group formation algorithm, as explained in step 250.

In an exemplary embodiment, step 260 further comprises generating a boarding pass which may comprise a unique access code associated with the shared ride created, such as, for example, a bar code or QR code. Alternative access codes and/or methods of access, in place of or in addition to printable or visual codes may be provided in method 200, as would be readily understood to one of ordinary skill in the art. In an exemplary embodiment, the processor 180 generates the boarding pass and it is stored in memory 160. The boarding pass may be displayed to the commuter on display 120 by accessing the commuter's user account. The commuter may use the boarding pass to gain entry to the shared ride. In an exemplary embodiment, the driver will scan the boarding pass with a known scanning device to record entry of the commuter to the shared ride, although the invention is not so limited and may include other structure for recording entry of the commuter to the shared ride. In another exemplary embodiment, the driver and commuter may have a mobile application which facilitates the scanning process and tracks participation of the commuter in the rideshare system. Exemplary displays of a commuter boarding pass are shown in FIGS. 3Q-3R.

In an exemplary embodiment, once a shared ride is created, data associated with it is stored in memory 160 and the processor 180 is programmed to update the business dashboard associated with the subscribed entity with information about the shared ride created. In another exemplary embodiment, step 260 further comprises transmitting ride details to the driver of the created ride. Ride details may comprise the ride itinerary, rider information (i.e. contact information for each rider in the shared ride, such as name, address and/or email address), pickup location, and driver savings information, such as the amount of money saved by being the driver of the shared ride. An illustration of an exemplary display of ride details generated by the rideshare system 100 and transmitted to the driver is shown in FIG. 3S.

An aspect of the invention provides a business dashboard associated with each subscribed entity to, for example, display data associated with shared rides set up through systems of the invention, and manage ride assets deployed in the field. For example, ride and rider information shown on a business dashboard may comprise one or more destination addresses, a map, and ride metrics, such as, for example, a total number of rides created to the destination address, a total number of commuters using the system, and usage information. The business dashboard may also display historical metrics of a rider's use of the shared ride system. The map may illustrate the geographic location of the destination address, the drivers, and the riders, and may show a perimeter indicating the geographical area encompassed by one or more shared rides. An illustration of an exemplary display of the concept of illustrating a map showing information on a business dashboard is shown in FIG. 3T.

Usage information may include business analytics, such as website usage, email clicks, and mobile application interactions with the rideshare system. For example, in one embodiment, the processor portion 180 may count the number of times one or more of the business analytics has been selected by a user, and display those numbers via the business dashboard on the display portion 120. Usage information may also comprise vehicle telemetry information, which tracks the performance of ride assets. In an exemplary embodiment, the business dashboard may also provide additional information about the shared rides, such as commuter feedback and vehicle maintenance history, scheduled service, and reported problems. In an exemplary embodiment, systems of the invention collect this information via input 140, process it via processor 180 and store it in memory 160. In an exemplary embodiment where the subscribed entity is an employer, this information may be useful to verify proper billing where the subscribed entity subsidizes all or part of the cost of using the rideshare system, and to monitor employee participation in the commuting program for sustainability and employee benefit purposes.

Aspects of the invention may provide registered users with an option to modify a single ride in advance, or in real-time, to account for a planned or unexpected change in the user's commuting schedule. In an exemplary embodiment, a user may access its user account and request a one-time ride. The rideshare system 100 receives the request, and processes it to determine if an existing shared ride has capacity to meet the request. If the request can be met, rideshare system 100 transmits ride itinerary information to the user for the single ride. If an existing shared ride does not exist to meet the request, the rideshare system 100 may schedule or suggest scheduling a one-time ride with a transportation provider having an asset available to meet the request.

Aspects of the invention may provide registered users with an option to suspend billing should the user not need the service for reasons such as vacation, business travel, prolonged illness or medical surgery. If this user is a rider, the system will permit the shared ride to continue in the absence of this user, if the remaining users wish to continue the shared ride. If this user is a driver, the system will attempt to identify another driver within the existing group. If the system is unable to identify another driver within the existing group, the system will place the riders back into the ridematching system and identify another ride for them, if there are suitable and available assets in the system.

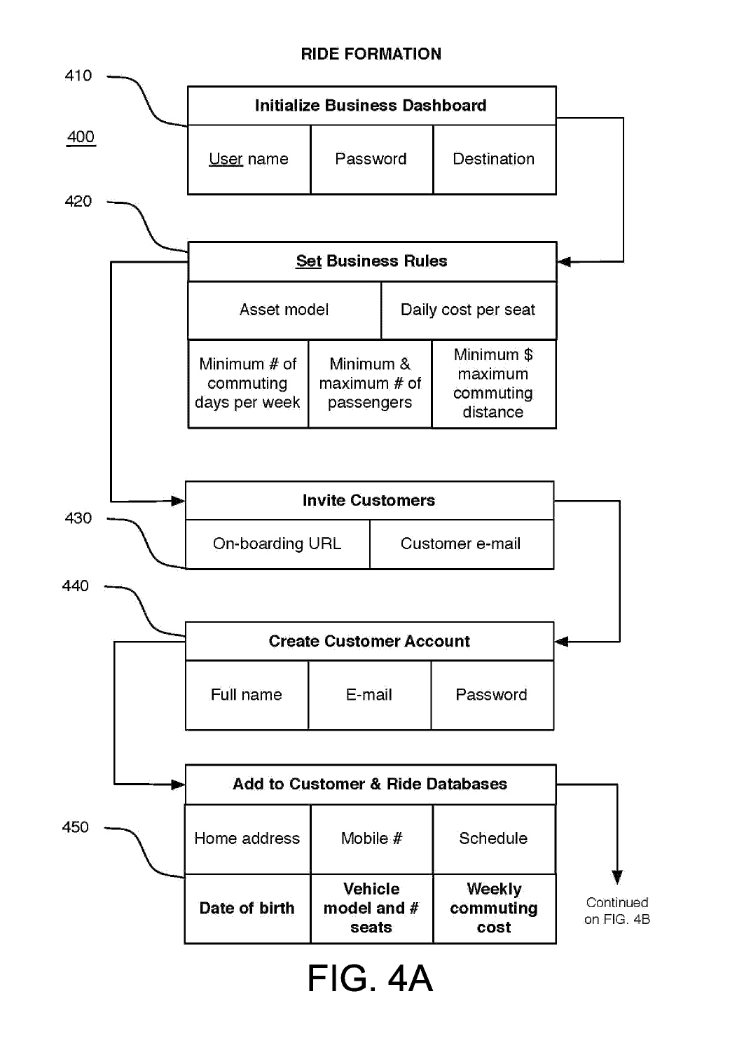

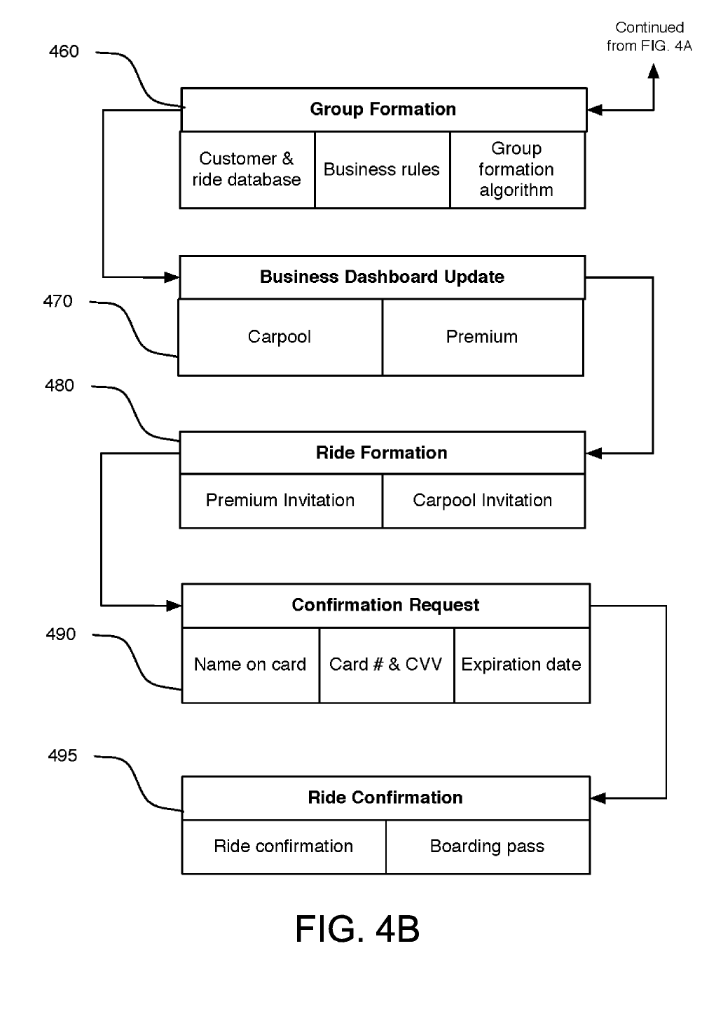

Methods and systems of the invention are carried out once a shared ride is formed, by drivers driving the asset to one or more pickup locations, riders entering the asset at one or more pick-up locations, and drivers driving those riders in the asset to the destination address or destination area. FIGS. 4A-4B shows another exemplary method 400 for forming a shared ride in accordance with aspects of the present invention. One or more of the steps of a method 400 may be implemented on a computer system, such as rideshare system 100. Other suitable systems for implementing the method 400 will be understood by one of skill in the art from the description herein.

At step 410, a business dashboard is initialized by a subscribing entity. The entity provides a user name, a password, and a destination address. At step 420, the subscribed entity sets business rules for creation of shared rides, which may be based on an asset model or a weekly subscription model, such as a cost per seat model. The business rules may include a minimum number of commuting days per week, minimum and maximum number of passengers traveling in the asset, and minimum and maximum commuting distances of the commuter. At step 430, an on-boarding URL is created for the gathering of commuter information that may ultimately lead to creation of a shared ride, and customers are invited via e-mail to join the rideshare system. At step 440, a customer who clicks on the on-boarding URL, will be prompted to create a customer account, which includes the customer's full name, e-mail, and desired password. At step 450, additional customer information may be collected, including the customer's home address, mobile number, commuting schedule, date of birth, model of vehicle currently used to travel to the destination address and the number of seats in the vehicle, and current weekly commuting cost. In an exemplary embodiment, the system will calculate the driver's estimated fuel costs and the number of seats in the driver's vehicle based on the make and model of the driver's vehicle and the distance of the driver's commute to work. In an exemplary embodiment, the customer information received from each customer by rideshare system 100, is processed by processor 180 and stored in a customer database in memory 160 of the rideshare system 100. In this exemplary embodiment, memory 160 also has a ride database of shared rides previously created by the rideshare system 100.

FIG. 4B is a continuation of the steps of the exemplary method 400 shown in FIG. 4A. At step 460, a rideshare group is formed by analyzing at least one of the customer and ride databases, applying one or more business rules, executing a group formation algorithm, and forming a group of commuters from the customer database to be invited to join a shared ride. At step 470, the business dashboard is updated to indicate whether the potential shared ride will be a carpool (i.e. using an asset of one of the commuters) or a premium ride (i.e. using an asset provided by another, such as the subscribed entity, vRide, Inc. or its affiliates or a third party). Embodiments of the invention may include providing authorized third party users with access to the rideshare system 100 to add an asset for use by users of the system. For example, a third-party business may desire to place assets in service in the rideshare system for the purpose of being compensated for the assets use. At step 480, an invitation is sent to the group of commuters to join the shared ride. If the shared ride is to be a premium ride, a premium invitation is sent. If the shared ride is to be a carpool, a carpool invitation is sent. At step 490, commuters who accept the invitation provide payment information, which may be credit card information or other means of payment At step 495, a ride confirmation is sent to commuters who accept the invitation before the capacity of the asset is reached. In an exemplary embodiment, if the capacity of the asset is reached at the time the commuter accepts the invitation, the commuter is notified and/or is placed back into the system for consideration during the formation of other shared rides. After the rider accepts the invitation, the system digitally transmits a short message service (SMS) or similar message with a unique code to the rider. Prior to the rider's first ride in the shared commute, the rider provides the unique code to the driver who then sends an SMS to the system to confirm that the rider is riding in the shared ride and rider billing commences.

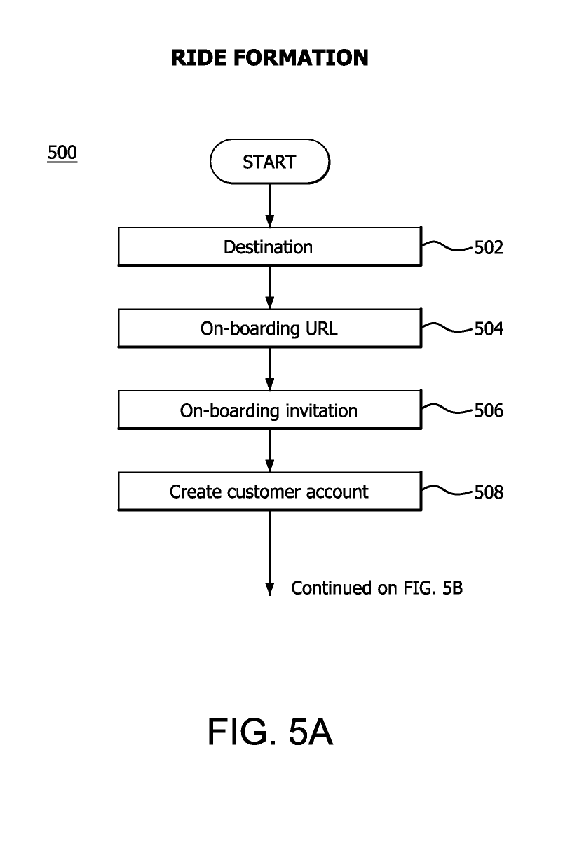

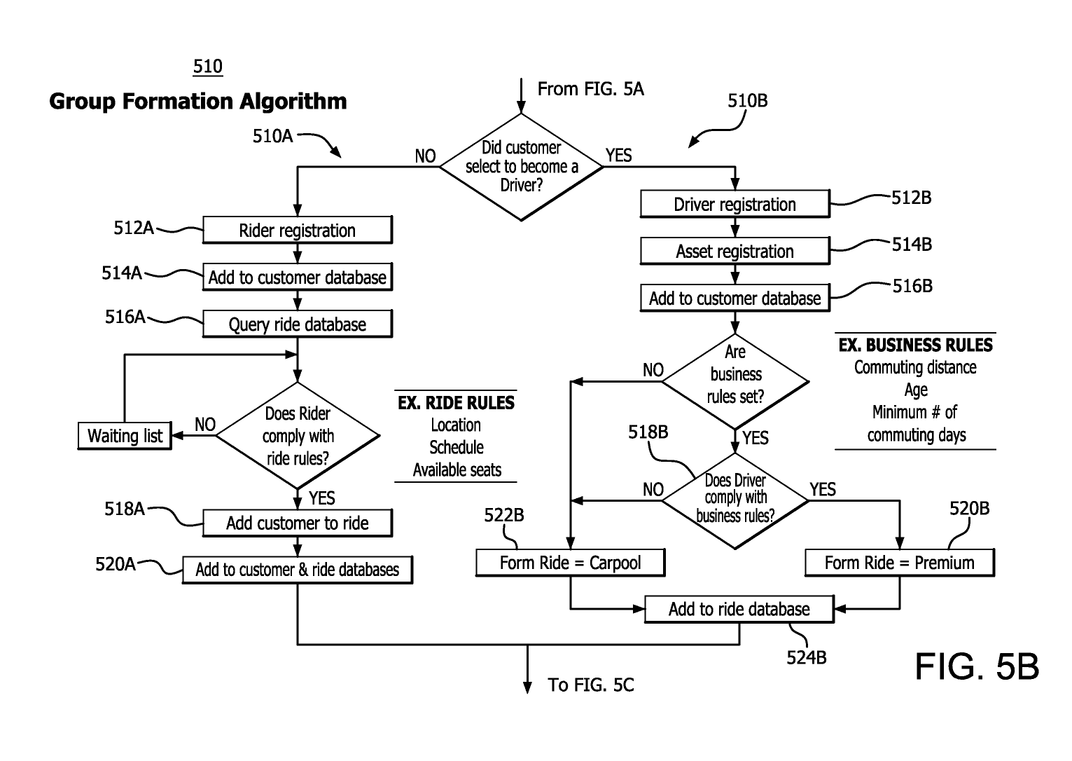

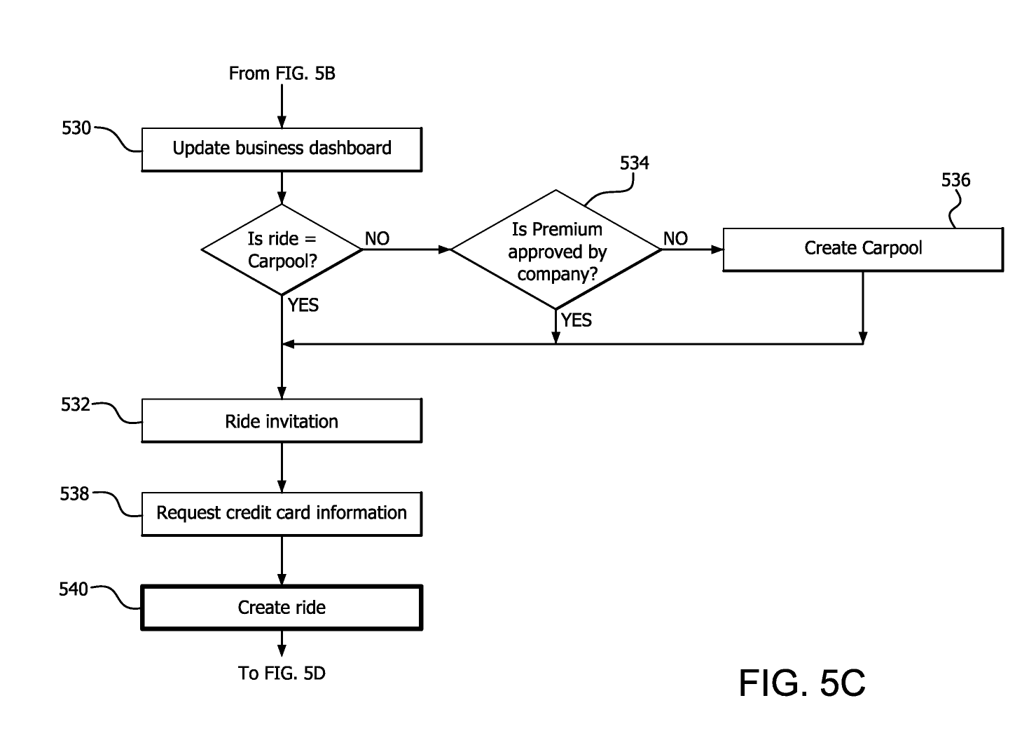

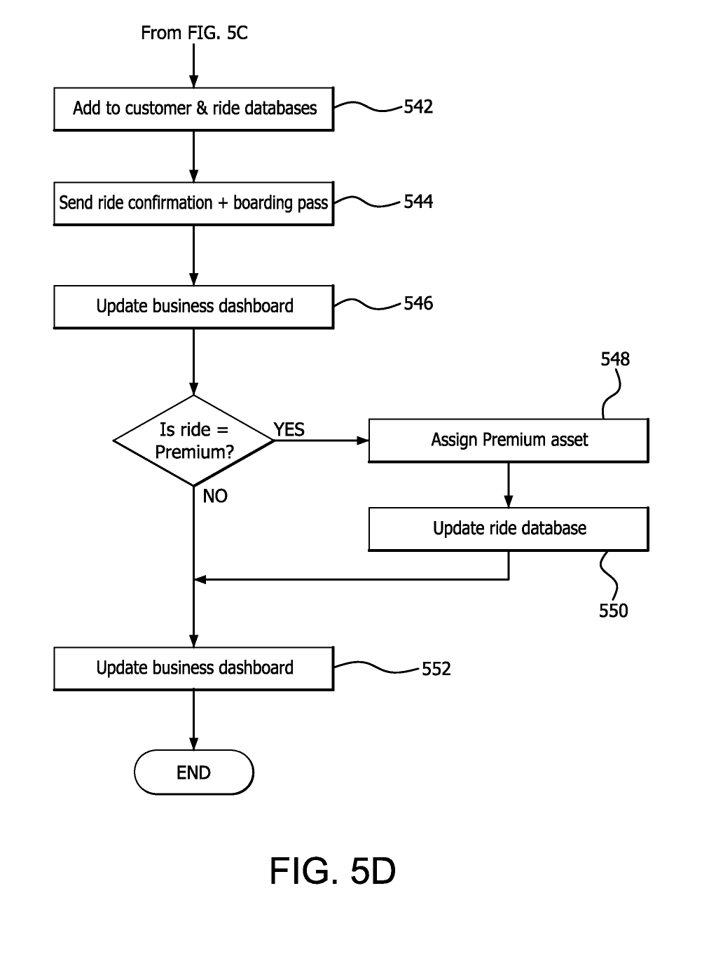

FIGS. 5A-5D depict a flowchart 500 for forming a shared ride in accordance with aspects of the invention. One or more of the steps and flow chart 500 may be implemented on a computer system, such as ridesharing system 100. Other suitable systems for implementing the flowchart will be understood by one of skill in the art from the description herein.

Starting at FIG. 5A, at step 502, a destination address is received. At step 504, an on-boarding URL is generated. An on-boarding URL may be, for example, a URL associated with the destination address. The on-boarding URL may be used during steps of methods of the invention as a mechanism to connect users of the system to one or more shared rides traveling to the destination address or destination area. At step 506, and on-boarding invitation is generated and digitally transmitted to potential customers. The on-boarding invitation comprises the on-boarding URL. At step 508, a customer account is created. In preferred embodiments, this step comprises receiving contact information from a prospective commuter.

FIG. 5B depicts a flowchart of step 510 of method 500. At step 510, a rideshare group is formed. Step 510 includes a number of substeps to form the rideshare group, as depicted in FIG. 5B. If the customer did not elect to be a driver in step 508, path 510A of the flowchart is followed. If the customer elected to be a driver in step 508, path 510B is followed.

At step 512A, rider registration information is received from a non-driving commuter. At step 514A, the rider registration information is added to a customer database. At step 516A, a ride database is queried to determine whether the non-driving commuter registration information matches with an existing ride that has capacity for additional riders, or a rideshare group currently being formed. Whether commuter registration information matches with an existing ride or a shared ride may depend on one or more ride rules, such as, for example, commuter location, commuter schedule, route to work, traffic patterns, distance from workplace relative to distance from the commuter's homes, or calculations to maximize or minimize the number of routes or available seats. As depicted in FIG. 5B, if the commuter registration information satisfies the one or more ride rules, the commuter is added to the rideshare group for the matched ride at step 518A. If the commuter registration information does not satisfy the one or more ride rules, then the commuter is placed on a waiting list for future queries to form a rideshare group. At step 520A, the customer database and ride database are updated to reflect that the commuter has been added to a rideshare group in step 518A.

At step 512B, driver registration information is received from a commuter who selected to be a driver in step 508. At step 514B, asset information is received from the driving commuter. In an exemplary embodiment, asset information comprises information related to the vehicle the driver currently uses to travel to the destination address, and/or the vehicle the driver intends to use to travel to the destination address as a part of the rideshare system. At step 516B, the customer database is updated with the driver registration information and the asset information. In an exemplary embodiment of the method 500, if one or more business rules, ride rules, and/or ride input factors are received, it is determined at step 518B whether the driver registration information complies with such rules and/or factors. A premium ride is formed at step 520B if the driver registration information satisfies rules and/or factors related to whether the driver qualifies for the premium ride. If no business rules, ride rules, and/or ride input factors are received, or they are received but the driver registration information does not satisfy criteria required to form a premium ride, a carpool is formed at step 522B. Once either a premium ride is formed at step 520B, or a carpool is formed at step 522B, the ride database is updated at step 524B.

FIG. 5C is a continuation from FIG. 5B of the exemplary embodiment of method 500. In a preferred embodiment, at step 530, the business dashboard is updated with at least some of the information received and/or generated by the substeps of method 510. Step 530 may occur before or after any of the remaining steps of method 500. Preferably, the business dashboard is updated to reflect that a new ride was formed, and that a new driver or rider has registered for a shared ride. If a carpool was formed at step 522B, a carpool ride invitation is sent to the customer at step 532. If the ride formed in steps 522B or 520B is a premium ride (i.e. not a carpool), it is determined at step 534 whether a premium ride is approved by an authorized user or administrator. If a premium ride is formed but not approved by an authorized user or administrator, then a carpool is formed at step 536. If a premium ride is approved by an authorized user, a premium ride invitation is sent to the driver at step 532. In some embodiments, a commuter may decline an invitation, at which point the commuter will be placed on a waiting list for future queries to form a rideshare group. At step 538, payment information, preferably credit card information of the customer, is requested. At step 540, once the payment information is confirmed, a shared ride is created. Preferably, registration information for more than two customers is available in the customer database before a shared ride is created.

FIG. 5D is a continuation from FIG. 5C of the exemplary embodiment of method 500. At step 542, customer and/or ride databases are updated to add the shared ride information. At step 544, the customer sent a ride confirmation which preferably includes a boarding pass or unique code. At step 546, the business dashboard is updated with additional information about the shared ride. At step 548, if the shared ride is a premium ride, a premium asset is assigned and, at step 550, the ride database is updated with the premium asset information. At step 552, the business dashboard is updated.

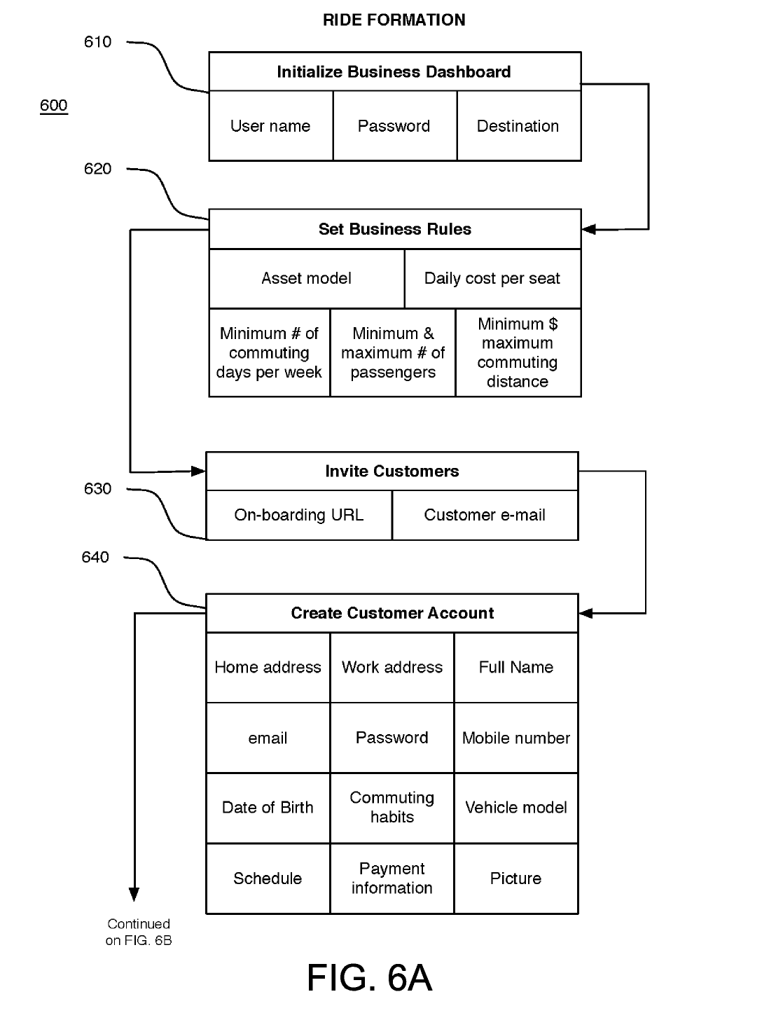

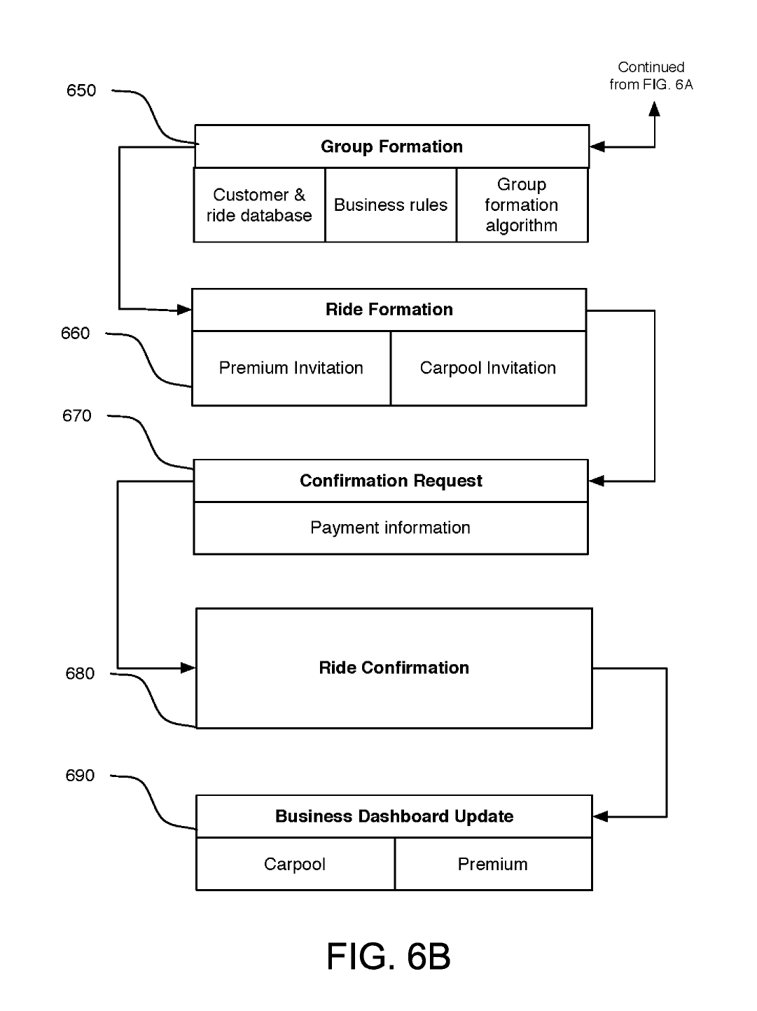

FIGS. 6A-6B shows another exemplary method 600 for forming a shared ride in accordance with aspects of the present invention. One or more of the steps of a method 600 may be implemented on a computer system, such as rideshare system 100. Other suitable systems for implementing the method 600 will be understood by one of skill in the art from the description herein.

At step 610, a business dashboard is initialized by a business entity. The entity provides a user name, a password, and a destination address. At step 620, the business entity sets business rules for creation of shared rides, which may be based on an asset model or a weekly subscription model, such as a cost per seat model. The business rules may include a minimum number of commuting days per week, minimum and maximum number of passengers traveling in the asset, and minimum and maximum commuting distances of the commuter. At step 630, an on-boarding URL is created for the shared ride, and customers are invited via e-mail or other electronic means such as, for example, a text message, to join the rideshare system by clicking on the URL. At step 640, a customer who clicks on the on-boarding URL, will be prompted to create a customer account. The customer may enter, for example, one or more of the following: customer's full name, home address, work address, e-mail, desired password, mobile telephone number, date of birth, commuting habits, vehicle model, schedule, payment information, and a picture. Commuting habits may include whether they currently drive to their destination, take a bus, taxi cab, carpool or vanpool. The business rules may also specify which customer account information is required and which is optional. In an exemplary embodiment, the customer information received from each customer by rideshare system 100, is processed by processor 180 and stored in a customer database in memory 160 of the rideshare system 100. In this exemplary embodiment, memory 160 also has a ride database of shared rides previously created by the rideshare system 100.

FIG. 6B is a continuation of the steps of the exemplary method 600 shown in FIG. 6A. At step 650, a rideshare group is formed by analyzing at least one of the customer and ride databases, applying one or more business rules, executing a group formation algorithm, and forming a group of commuters from the customer database to be invited to join a shared ride. At step 660, an invitation is sent to the group of commuters to join the shared ride. If the shared ride is to be a premium ride, a premium invitation is sent. If the shared ride is to be a carpool, a carpool invitation is sent. At step 670, commuters who accept the invitation provide payment information (unless already provided in step 640), which may be credit card information or other means of payment. At step 680, a ride confirmation is sent to commuters who accept the invitation before the capacity of the asset is reached. In an exemplary embodiment, if the capacity of the asset is reached at the time the commuter accepts the invitation, the commuter is notified and/or is placed back into the system for consideration during the formation of other shared rides. At step 690, the business dashboard is updated to indicate whether the potential shared ride will be a carpool (i.e. using an asset of one of the commuters) or a premium ride (i.e. using an asset provided by another, such as the subscribed entity, vRide, Inc. or its affiliates or a third party). Embodiments of the invention may include providing authorized third party users with access to the rideshare system 100 to add an asset for use by users of the system. For example, a third-party business may desire to place assets in service in the rideshare system for the purpose of being compensated for the assets use.

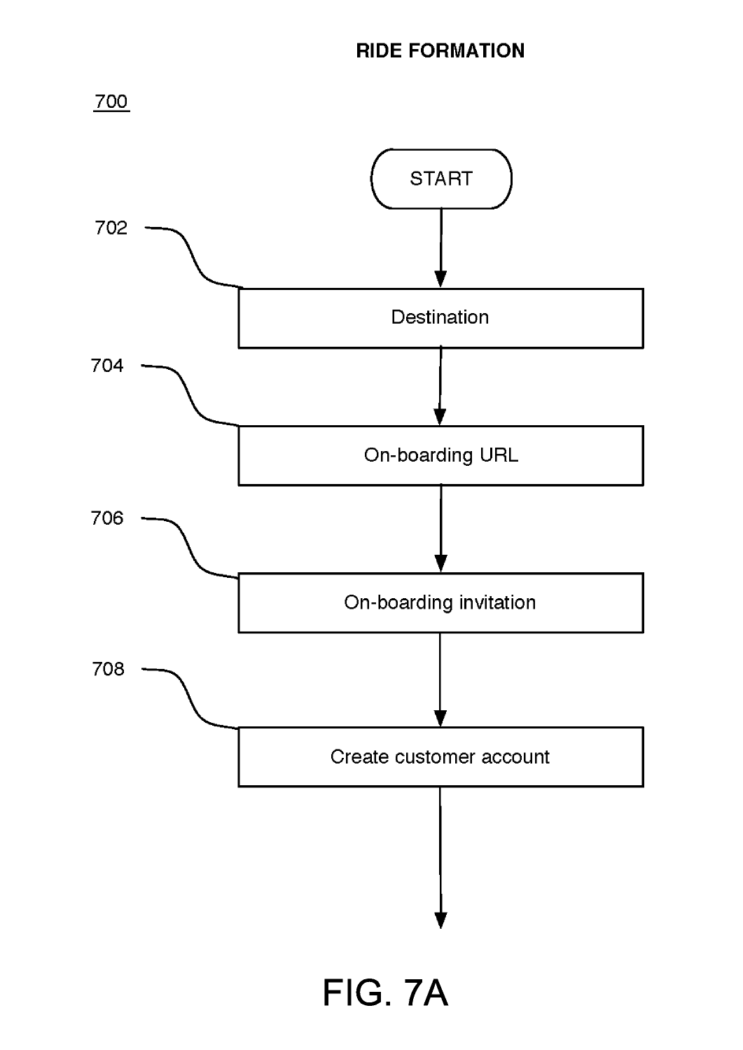

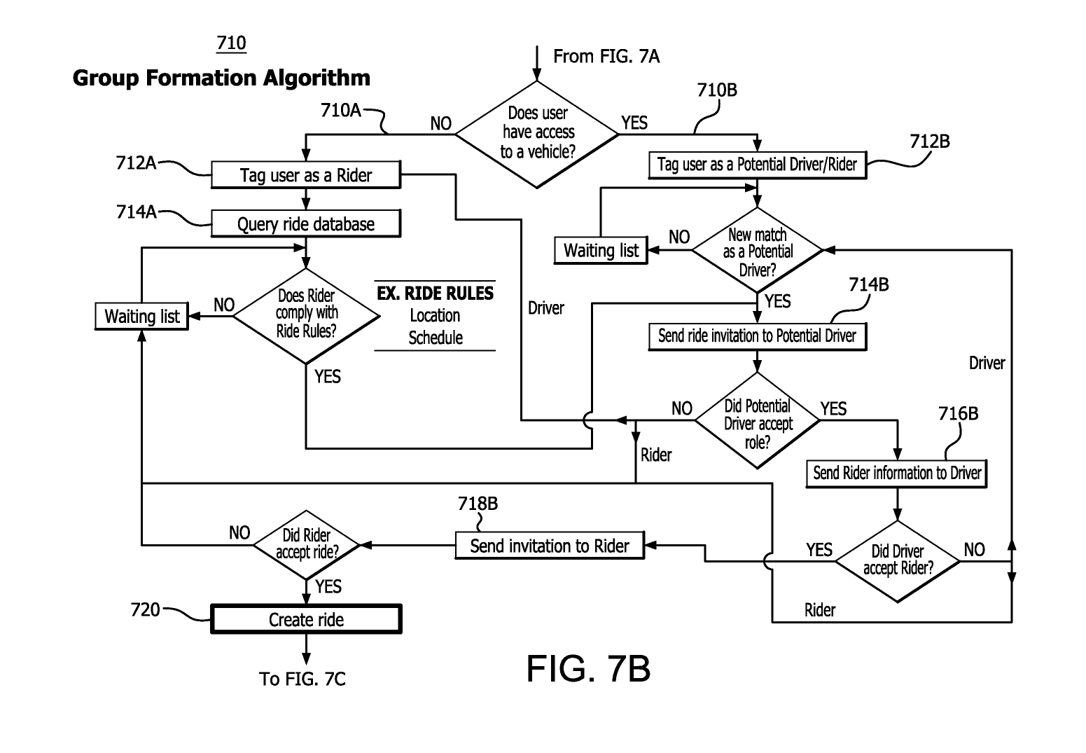

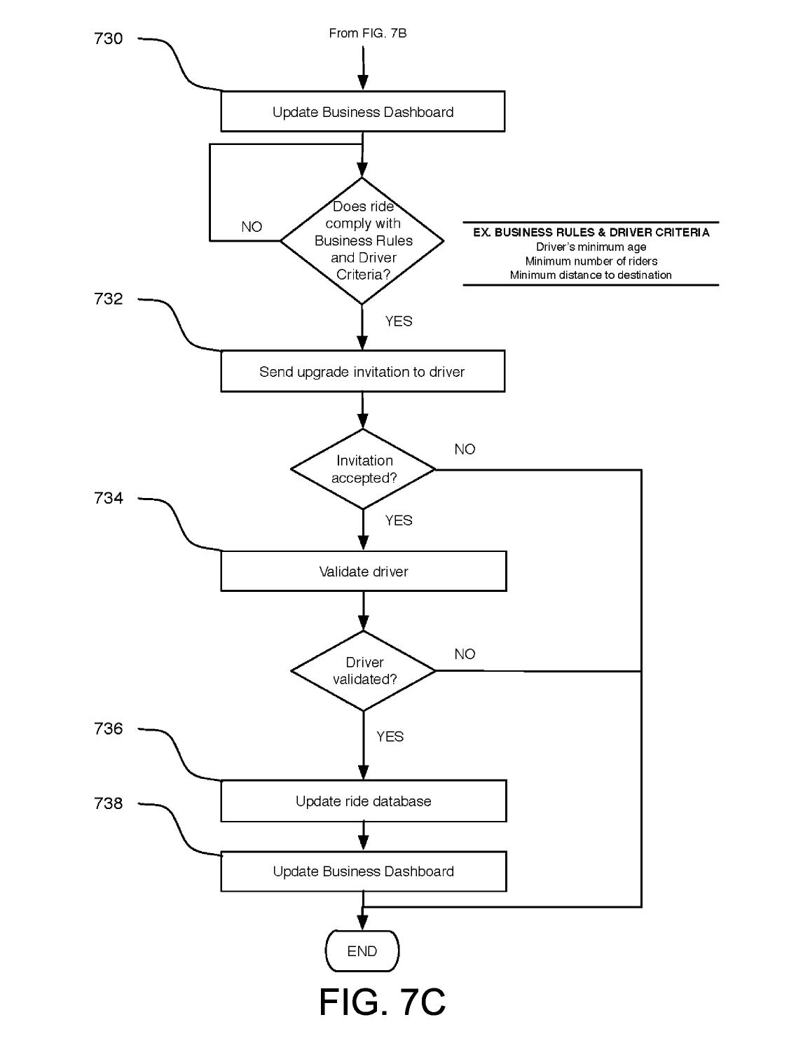

FIGS. 7A-7C depict a flowchart 700 for forming a shared ride in accordance with aspects of the invention. According to this embodiment, a shared ride that may be created as a result of the method may be either a carpool or a premium ride. One or more of the steps and flow chart 700 may be implemented on a computer system, such as ridesharing system 100. Other suitable systems for implementing the flowchart will be understood by one of skill in the art from the description herein.

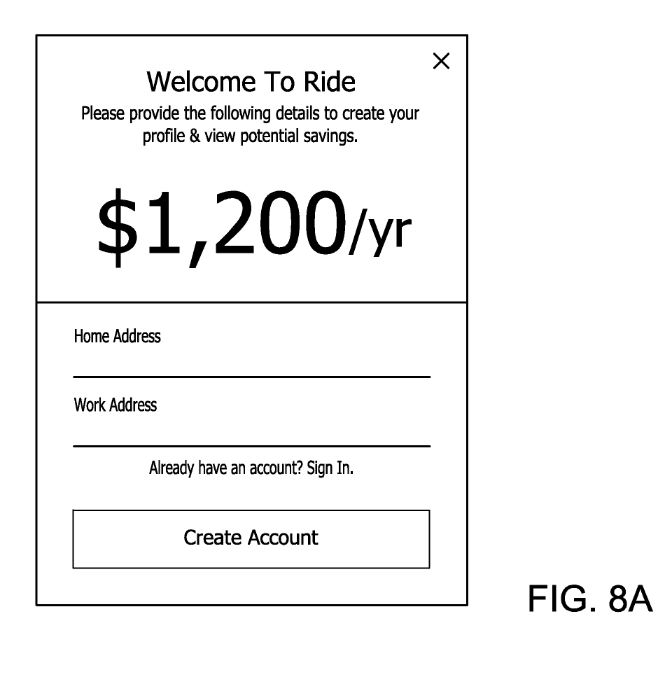

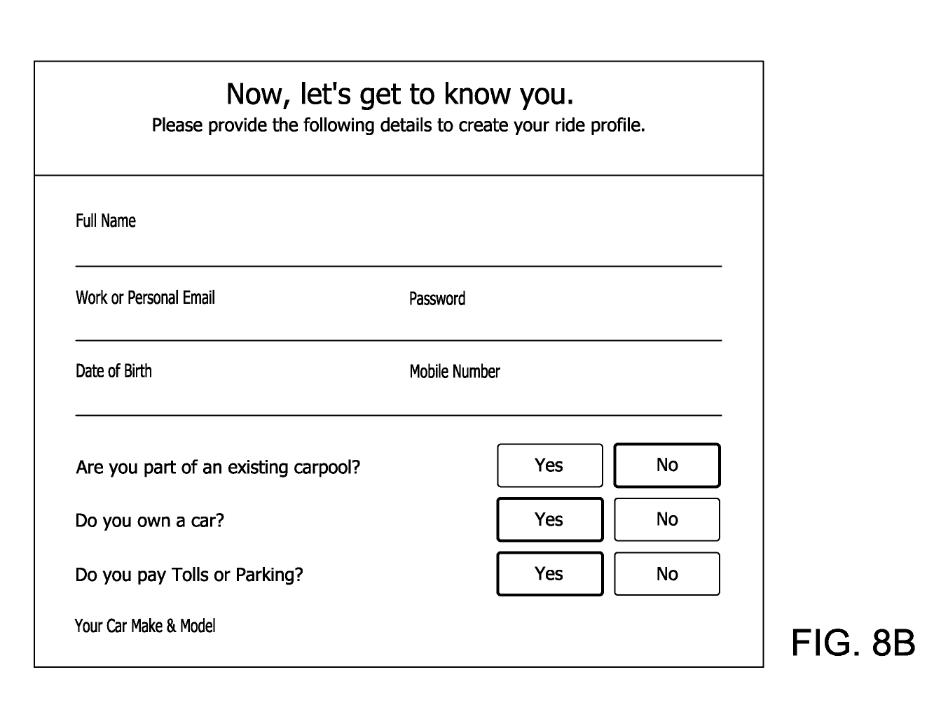

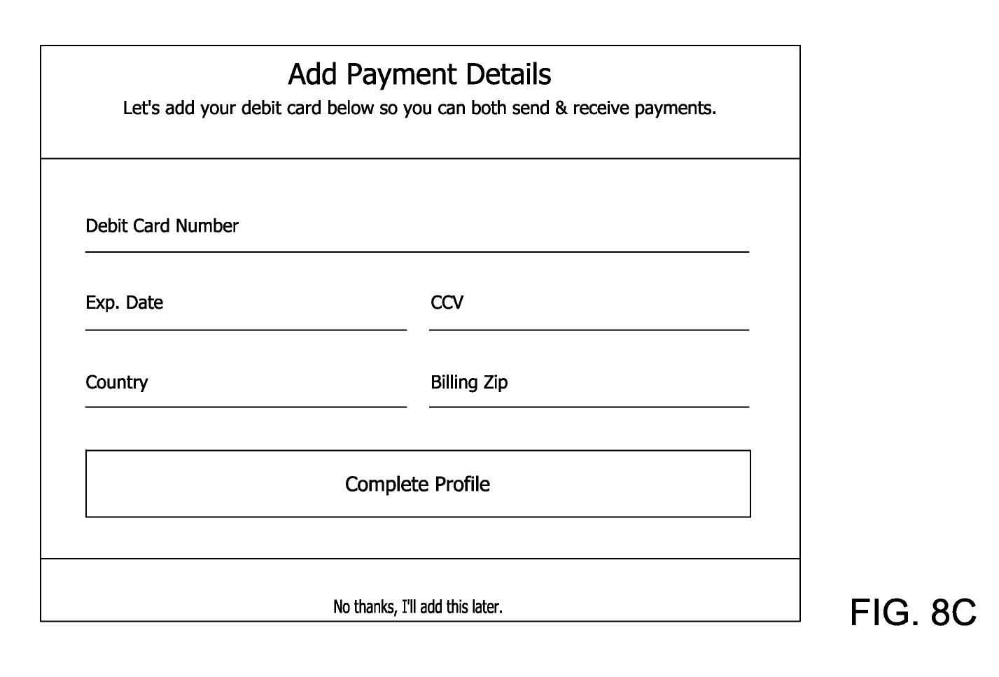

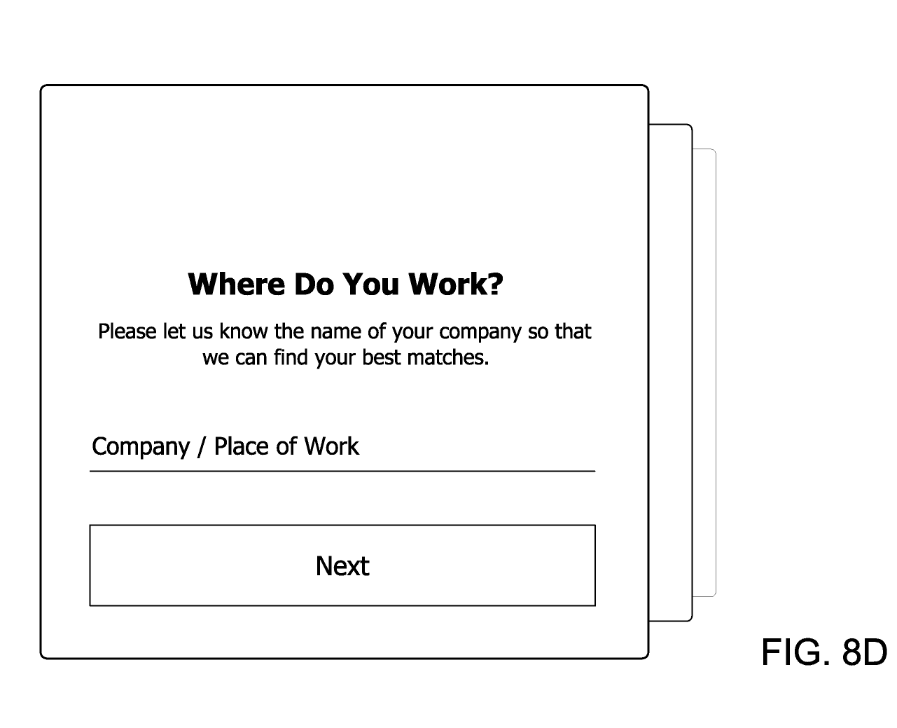

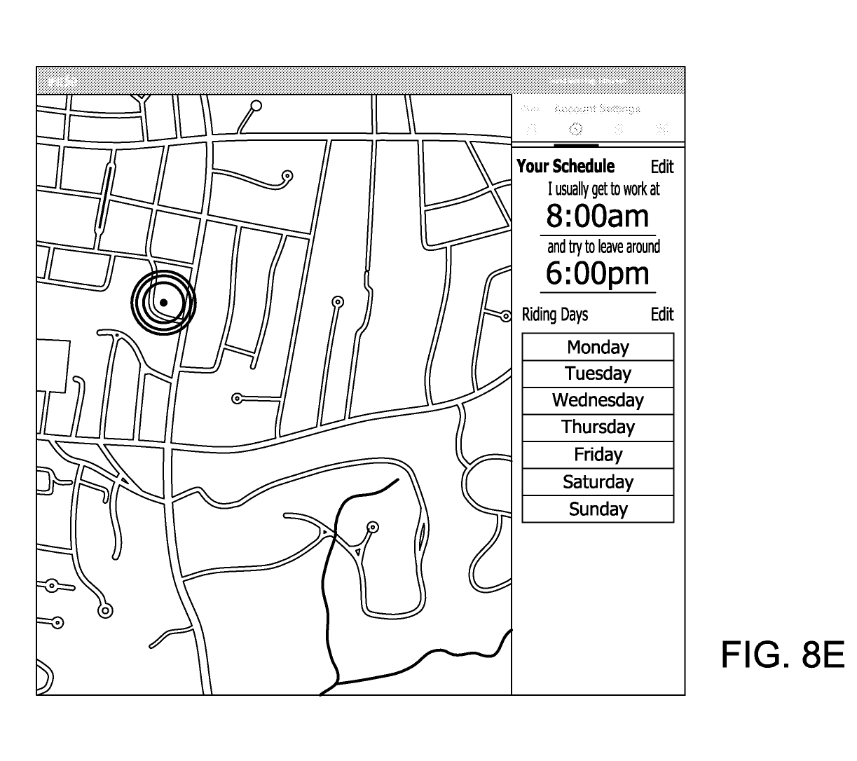

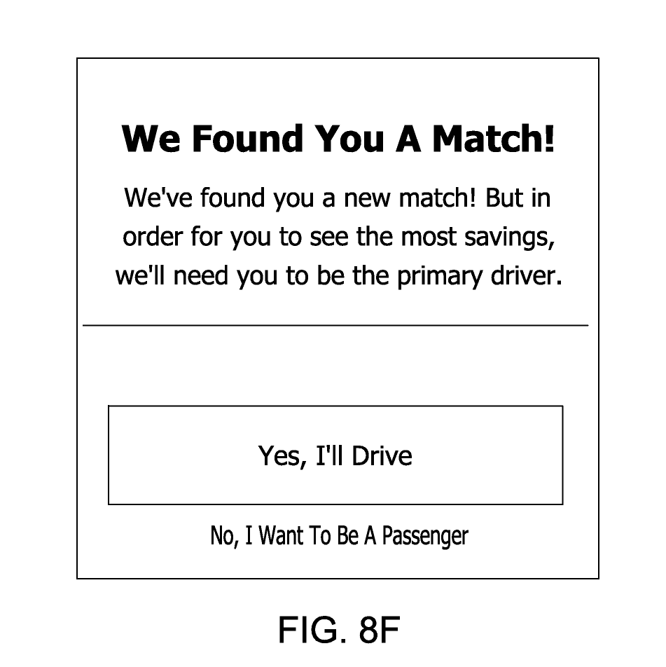

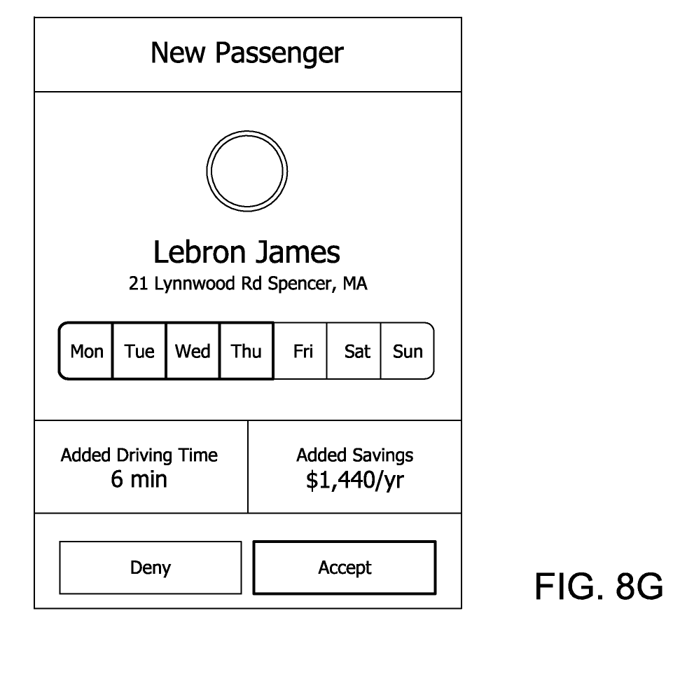

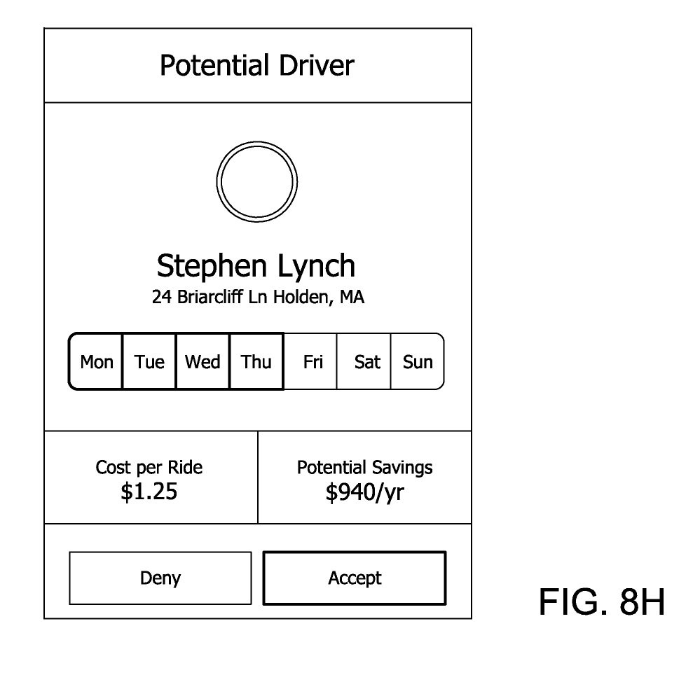

Starting at FIG. 7A, at step 702, a destination address is received. At step 704, an on-boarding URL is generated. An on-boarding URL may be, for example, a URL associated with the destination address or destination area. The on-boarding URL may be used during steps of methods of the invention as a mechanism to connect users of the system to one or more shared rides traveling to the destination address or destination area. At step 706, and on-boarding invitation is generated. The on-boarding invitation comprises the on-boarding URL. At step 708, a customer account is created. In preferred embodiments, this step comprises receiving contact information from a commuter, and information about whether the commuter has access to a vehicle (i.e. owns, rents, leases, or is able to borrow another's vehicle). Illustrations of exemplary displays for prompting input of commuter/customer registration information are shown in FIGS. 8A-8E.

FIG. 7B depicts a flowchart of step 710 of method 700. At step 710, a rideshare group is formed. Step 710 includes a number of substeps to form the rideshare group, as depicted in FIG. 7B. If the user does not have access to a vehicle, path 710A of the flowchart is followed and the user is tagged as a rider in step 712A. If the user has access to a vehicle, path 710B is followed, and the user is tagged as a potential driver/rider at step 712B.

Following the rider path, at step 714A, a ride database is queried to determine whether the customer account information matches with an existing ride that has capacity for additional riders, or a rideshare group currently being formed. Whether the customer account information matches with an existing ride or a shared ride may depend on one or more ride rules, such as, for example, commuter location, commuter schedule, route to work, traffic patterns, distance from workplace relative to distance from the commuter's homes, or calculations to maximize or minimize the number of routes or available seats. As depicted in FIG. 7B, if the customer account information satisfies the one or more ride rules, including that there is a potential driver that is a match for the rider, the process follows the path 714B, as described below. If the rider registration information does not satisfy the one or more ride rules, then the rider is placed on a waiting list that is fed back into the flow as shown in FIG. 7B

If the user is tagged as a potential driver/rider in step 712B, the ride database is then queried, according to this embodiment, to determine whether there is a rider that can be matched for a ride with the potential driver/rider. If there is not a match, the potential driver/rider is placed on a waiting list that is fed back into the flow as shown in. FIG. 7B. If there is a match, a ride invitation is sent to the potential driver/rider in step 714B, recommending that the potential driver accept the role of driver. An illustration of an exemplary display of a ride invitation recommending that the potential driver accept the role of driver is shown in FIG. 8F. If the potential driver/rider declines the driver role, the driver follows the path to step 712A, is re-tagged as a rider only, and follows that path beginning at step 714A. If the potential driver declines the driver's role, the rider who the potential driver was matched with is placed on the waiting list and fed back into the flow, as shown in FIG. 7B.

If the potential driver accepts the driver role, rider information is sent to the driver in step 716B, along with an invitation to accept or decline the rider. An illustration of an exemplary display of rider information sent to a driver is shown in FIG. 8G. Methods and systems of the invention may also calculate and provide to the driver information such as for example, the additional driving time to the destination if the driver accepts the rider, or actual or estimated cost savings per period (i.e. year, month, week etc.) for driving the rider to the destination. If the driver declines to accept the rider, the driver returns to potential driver status and a search is executed to determine if there is another rider available that complies with the ride rules and is a match for the potential driver, and the rider returns to the waiting list and is fed back into the flow, as shown in FIG. 7B. If the driver accepts the rider in step 716B, an invitation is sent to the rider, as shown in step 718B. An exemplary display inviting the rider to accept the driver is shown in FIG. 8H. Methods and systems of the invention may also calculate and provide to the rider information, such as for example, the actual or estimated cost per ride, or actual or estimated savings per period (i.e. year, month, week etc.), if the rider accepts pooling with driver to the destination. If the rider accepts the invitation in step 718B, a carpool is created at step 720.

FIG. 7C is a continuation from FIG. 7B of the exemplary embodiment of method 700. In a preferred embodiment, at step 730, the business dashboard is updated with at least some of the information received and/or generated by the substeps of method 710. Preferably, the business dashboard is updated to reflect that a new ride was formed, and that a new driver or rider has registered for a carpool.

Methods and systems of the invention contemplate upgrading the carpool to a premium ride, and processes to determine whether a carpool is eligible to become a premium ride. After the business dashboard is updated at step 730, at least one business rule and driver criteria are applied to the carpool. If the carpool does not comply with one or more of those rules or criteria, the carpool is fed back into the flow, as shown in FIG. 7C, or terminated at the driver's request. If the carpool complies with the business rules and driver criteria set by methods of the invention, and upgrade invitation is sent to the driver in step 732. If the driver does not accept the invitation, the ride remains a carpool. If the driver accepts the invitation at step 732, a driver validation process occurs at step 734. The driver validation process may include review of the driver criteria, the driver's motor vehicle driving records, accident history, and/or other rules and/or factors implemented within the method to determine whether the driver qualifies for the premium ride. If the driver is not validated, the carpool is fed back into the flow, as shown in FIG. 7C. If the driver is validated, the carpool is upgraded to a premium ride at step 736 and the business dashboard is updated at step 738 to reflect the change in ride status from carpool to premium ride.

The above-described exemplary methods may be performed by one or more processors executing one or more sequences of instructions for presenting information to a display, the one or more sequences of instructions stored on a non-transient computer readable medium. Execution of the one or more sequences of instructions causes the one or more processors to perform the steps of the above-described exemplary methods. Thus, it will be understood by one of ordinary skill in the art that embodiments of the invention are not limited to any specific combination of hardware and software.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A computer implemented method for scheduling a shared ride between at least a first commuter and a second commuter, the method comprising the steps of:
receiving, at a processor, a destination area and at least one ride input factor subscribed entity;
generating, at the processor, a unique URL associated with the destination area;
transmitting, directly or indirectly, the unique URL to the at least first commuter and the second commuter;
receiving, at the processor, commuter registration information comprising a first commuter registration information and a second commuter registration information, associated with the unique URL;
forming a rideshare group of commuters by applying a group formation algorithm with the processor to the commuter registration information, the destination area, and the at least one ride input factor to generate an output representing identity information for the rideshare group of commuters; and
scheduling the shared ride.

2. The method of claim 1, further comprising:
generating, at the processor, a ride invitation that is transmitted to the rideshare group of commuters;
receiving, at the processor, an acceptance of the ride invitation from at least two members of the rideshare group;
generating, at the processor, a boarding pass for the shared ride having a unique code; and
transmitting the boarding pass to the at least two members of the rideshare group.

3. The method of claim 1 wherein the commuter registration information is stored in a ride database in a memory, the second commuter registration information comprises a second commuter address information, and wherein the step of forming a rideshare group of commuters comprises the steps of:
determining, at the processor, whether the first commuter has access to a vehicle based on the first commuter registration information, and if so, classifying the first commuter as a potential driver of the shared ride;
querying the ride database, at the processor, to determine whether the second commuter is a match to ride with the potential driver;
if the second commuter is a match, generating, at the processor, a ride invitation to the potential driver comprising an invitation to accept a driver role, and transmitting said ride invitation to the potential driver;
if the potential driver accepts the driver role, generating, at the processor, an invitation to accept the second commuter for the ride, and transmitting the second commuter address information and said invitation to accept to the potential driver;
if the potential driver accepts the invitation to accept the second commuter for the ride, generating, at the processor, a second ride invitation to the second commuter, and transmitting an invitation to accept the second ride invitation to the second commuter; and
receiving, at the processor, a second commuter acceptance of the second ride invitation.

4. The method of claim 3, further comprising the step of:
generating, at the processor, a business dashboard for the subscribed entity and storing it in the memory after the step of receiving, at a processor, a destination area and at least one ride input factor from a subscribed entity,
and, after the step of receiving, at the processor, a second commuter acceptance of the second ride invitation, further comprising the steps of:
receiving, at the processor, the second commuter acceptance and updating the business dashboard that a carpool has been formed;
applying the group formation algorithm with the processor, a business rule and a driver criteria, to generate a ride upgrade invitation to the first commuter;
receiving, at the processor, a first commuter acceptance of the ride upgrade invitation;
generating, at the processor, a first commuter validation request; and
receiving, at the processor, an approval of the first commuter validation request and updating the ride database and the business dashboard that the first commuter is a validated driver.

5. The method of claim 4 further comprising the step of:
assigning a premium asset to the first commuter, and updating the business dashboard with vehicle information about the premium asset.

6. The method of claim 1 wherein the commuter registration information is stored in a ride database in a memory, the first commuter registration information comprises a first commuter address information, and wherein the step of forming a rideshare group of commuters further comprises the steps of:
determining, at the processor, whether the first commuter has access to a vehicle based on the first commuter registration information, and if not, classifying the first commuter as a rider of the shared ride;
querying the ride database, at the processor, to determine whether the first commuter address information is a match to an existing ride;
if there is a match, generating, at the processor, a ride invitation to a driver of the existing ride comprising an invitation to accept the first commuter, and transmitting said ride invitation to the driver;
if the driver accepts the invitation to accept the first commuter for the existing ride, generating, at the processor, a second ride invitation to the first commuter, and transmitting an invitation to accept the first ride invitation to the first commuter; and
receiving, at the processor, a first commuter acceptance of the first ride invitation.

7. The method of claim 6 wherein the step of querying the ride database comprises the step of applying the group formation algorithm with the processor to a ride rule to generate an output representing the match.

8. The method of claim 6 further comprising the step of:
generating, at the processor, a business dashboard for the subscribed entity and storing it in the memory, after the step of receiving, at a processor, a destination area and at least one ride input factor from a subscribed entity; and
after the step of receiving, at the processor, a first commuter acceptance of the first ride invitation, further comprising the steps of:
receiving, at the processor, the first commuter acceptance and updating the business dashboard that a carpool has been formed;
applying the group formation algorithm with the processor, a business rule and a driver criteria, to generate a ride upgrade invitation to the second commuter;
receiving, at the processor, a second commuter acceptance of the ride upgrade invitation;
generating, at the processor, a second commuter validation request; and
receiving, at the processor, an approval of the second commuter validation request.

9. The method of claim 8 further comprising the steps of updating the ride database and the business dashboard in the memory that the second commuter is a validated driver.

10. A rideshare system for scheduling a shared ride between a first commuter and a second commuter, the system comprising:
a display portion for presenting information to the first commuter and second commuter;
an input portion;
a memory portion for storing commuter registration information and subscribed entity information; and
one or more processors operable to control the information displayed on the display portion, and the commuter registration information and subscribed entity information in the memory portion, wherein execution of the one or more sequences of instructions by one or more processors causes the one or more processors to perform the steps of claim 1.

11. A computer implemented method for creating a shared ride, the method comprising the steps of;
receiving, at a processor, data comprising access information, a destination address, and at least one ride input factor from a subscribed entity;
receiving, at the processor, data from the at least two commuters comprising commuter registration information; and
forming a rideshare group by applying a group formation algorithm with the processor to the data from the at least two commuters, the destination address, and the at least one ride input factor to generate an output representing identity information for the rideshare group of commuters.
